(19) United States
(12) Patent Application Publication
(10) Pub. No.: US 2018/0338196 A1
(43) Pub. Date: Nov. 22, 2018

(54) HEADPHONE CORD ATTACHMENT MECHANISM

(71) Applicant: GOOGLE INC., Mountain View, CA (US)

(72) Inventor: Daniel A. Freedman, Austin, TX (US)

(21) Appl. No.: 15/542,478

(22) PCT Filed: Jan. 8, 2016
(86) PCT No.: PCT/US16/12575

§ 371 Date: Jul. 13, 2017

Related U.S. Application Data
(60) Provisional application No. 62/101,545, filed on Jan. 9, 2015.

(51) Int. Cl. H04R 1/10

(52) U.S. Cl. CPC H04R 1/1033

(57) ABSTRACT

Decorative items for adorning headphone cords may be refrictionally engages the cord. The decorative item may comprise an object having a lateral surface, and the groove may extend multiple turns around that lateral surface. The object may be cylindrical, with the lateral surface extending between two opposing circular faces. The groove may extend helically from a first circular face to the second circular face, and may further provide for the cord to be engaged with the groove from one face to the other.

### CROSS-REFERENCE TO RELATED APPLICATIONS

This application claims the benefit of provisional patent application Ser. No. 62/101,545, entitled “Headphone Cord Attachment Mechanism,” filed on Jan. 9, 2015, which is incorporated herein by reference.

### FIELD OF INVENTION

The present invention relates to an attachment mechanism to a cord associated with an audio headphone. More particularly, the present invention relates to releasably attaching decorative or other object(s) to a headphone cord.

### BACKGROUND AND DESCRIPTION OF THE RELATED ART

The development and rapid adoption of personal audio and/or telecommunication devices have lead to individuals frequently wearing headphones, both in private and in the company of others. Headphones may take a variety of forms, such as “earbuds” that may be inserted into the ear canal, “over-the-ear” headphones that entirely or partially cover the ear(s), “headsets” that combine microphones with headphones (particularly useful for telecommunications, audio recording, and/or voice interaction with a computing device), “single-ear” headphones, and a variety of other configurations. While some headphones may operate wirelessly, using protocols such as BlueTooth®, one or more cord is often used to provide a signal to the speakers that provide sound to the wearer of the headphones.

Of course, many headphone manufacturers attempt to produce headphones that are attractive, at least attractive in manners that appeal to the target consumers of the manufacturer's brand(s). However, decorative elements provided as part of the headphones themselves are at least quasi-permanent, and such quasi-permanence in the decorative aspects of a pair of headphones may be a commercial disadvantage in the face of rapidly changing fashion and popular culture trends. Further, many headphones, particularly inexpensive headphones such as may be purchased by parents for children, may frequently be replaced due to damage, wear, or loss and, therefore, any decorative component formed as a part of those headphones may be lost.

Decorative adornments may be applied to headphones, for example by using glue or another adhesive to affix decorative elements to various surfaces of a headphone. Decorative items may be clipped or clamped to the cord(s) of headphones as well. However, the use of adhesives makes transferring decorative elements to new headphones difficult or even impossible. Further, clipping or clamping a decorative item to a cord can damage the cord and can increase the likelihood that the decorative item may fall off the cord or otherwise slip along the cord, while also requiring that the decorative item be manufactured with a clamp or clip, thereby raising the cost and/or potential failure rate of the item.

### SUMMARY OF THE INVENTION

The present invention uses a groove to attach one or more decorative object to the cord(s) of headphones. For example, a groove may extend multiple turns around the exterior lateral surface of an object. The groove may be dimensioned such that the floor and/or opposing walls of the groove frictionally engage a cord inserted into the groove. Optionally, a lip or other structure may serve to retain a cord within the groove once sufficient pressure has been applied to the cord to insert it into the groove initially. Materials may be selected for the construction of the decorative object itself, and/or for inclusion as all or part of the walls/floor of a groove to provide a desired coefficient of friction between a cord and the walls/floor of the groove, and/or a desired amount of resilience in receiving/releasing a cord inserted into the groove. By extending the groove around the exterior lateral surface of the object for multiple turns, the surface area of the cord frictionally engaged to retain the decorative object may be increased within a relatively small distance measured along the lateral surface.

An object in accordance with the present invention may comprise any solid having a surface with at least one indentation that receives and retains a headphone cord to attach the object to the cord. The indentation may be configured to frictionally retain a headphone cord. Such configuration may be accomplished through the dimensions of the indentation relative to the cord to be received, the materials used as part of the indentation, the shape of the indentation itself, and the particular pathway of the indentation within, about, and/or around the object. While objects in accordance with the present invention are generally described as decorative, they need not be solely or at all decorative. For example, an object in accordance with the present invention may provide identification information or medical information describing the user. Further, cavities or further indentations may be provided within an object to receive items of an appropriate size and weight for transport. In some examples, electronics may be embedded on or within an object, with those electronics being accessible by a physical port and/or through wireless electromagnetic interaction.

An object in accordance with the present invention may be of any shape. In one example described herein, an object in accordance with the present invention may be substantially cylindrical, with a first circular face and a second circular face located on opposing ends of the axis of the cylinder. If the object is not cylindrical, however, the first face and the second face need not be circular. In some examples (such as a cone-shaped object), only a single face may be provided, while in other examples (such as a sphere) there may be no faces at all. In the example of a cylindrical object in accordance with the present invention, a groove may be provided in the lateral surface of the cylinder, extending from the first circular face to the second circular face in a helix or spiral, although the groove may extend in fashions other than helical or spiral. The groove may terminate at one or both of the faces such that a cord may be engaged/disengaged with the groove from one or both of the faces. The object may have an exterior diameter (for example, across the width of the object from opposing portions of the lateral surface) exceeding the interior diameter of the core defined by the floor of the groove and around which a cord may be wrapped. The depth at which a cord is retained below the lateral exterior surface may be varied by altering the difference between the exterior diameter and the interior diameter, although the depth of the groove need not be constant and may vary in other fashions as well. A decorative object in accordance with the present invention need not be cylindrical and, even if cylindrical, need not be a right cylinder. The exterior surface of the object may be the surface of any three-dimensional bounded object, such as, for example, cylinders, ellipsoids, cones, and polyhedra, and/or surfaces on irregular solid objects.

The object retained via a groove engaging the cord(s) of headphones in accordance with the present invention may be decorative in and of itself by way of pleasing proportions and/or attractive materials. Further, the arrangement and/or constitution of a groove or grooves may be intrinsically attractive. Additionally, the resulting appearance of a cord retained within a groove or grooves may have intrinsic aesthetic appeal. Additional decorative elements may be provided, however. For example, the portions of the lateral surface not occupied by a groove may provide decorative elements. Decorative elements may comprise graphical depictions (formed, for example, using pigments applied to the surface or contained within the material used to form the object), items applied or affixed to the surface, a two-dimensional relief formed on/into the surface, or any other element provided on the lateral surface or even on other surfaces of the object (such as the opposing circular faces in the example of a cylindrical object).

### BRIEF DESCRIPTION OF THE SEVERAL VIEWS OF THE DRAWINGS

Examples of systems and methods in accordance with the present invention are described in conjunction with the attached drawings, wherein:

FIGS. 1, 2, 3, 4a, 4b, 5a, 5b, 6a, and 6b illustrate an embodiment of an object in accordance with the present invention;

FIGS. 7, 8, 9, 10a, 10b, Ila, 11b, 12a, 12b, and 12c illustrate an alternate embodiment of an object in accordance with the present invention;

FIGS. 13a, 13b, 14a, 14b, 15a, and 15b illustrate an example of a groove that may frictionally retain a headphone cord in accordance with the present invention;

FIGS. 16, 17, and 18 illustrate an example of a support structure for the object in accordance with the present invention;

FIGS. 19, 20a, and 20b illustrate an alternate example of a support structure for the object in accordance with the present invention;

FIGS. 21 and 22 illustrate a further example of a support structure for the object in accordance with the present invention;

FIGS. 23 and 24 illustrate an example of ornamentation and other decorative aspects of the object in accordance with the present invention;

FIGS. 25, 26, and 27 illustrate an alternate example of ornamentation and other decorative aspects of the object in accordance with the present invention;

FIGS. 28, 29, 30, and 31 illustrate a further example of ornamentation and other decorative aspects of the object in accordance with the present invention; and

FIG. 32 illustrates a flow-chart depicting a method for affixing an object to a cord.

### DETAILED DESCRIPTION OF SPECIFICATION

In accordance with the present invention, a decorative object may be affixed to one or more headphone cord using a groove formed into an exterior surface of the decorative object. In instances where the object is formed from multiple surfaces, the groove may be contained partially or solely within a lateral surface of the object that extends generally in the direction of the headphone cord to be engaged, i.e. generally along a path from the user's device to a speaker of user's headphone. The cord may be frictionally retained within the groove, thereby preventing the object from falling from the cord, from being easily dislodged from the cord, from sliding along the length of the cord, and/or from rotating along the cord, while the headphones are in use. Tension in the cord may help ensure frictional contact between the cord and the object. Tension in the cord may be provided by one or more mechanisms, including, but not limited to: gravitational forces acting on the cord, gravitational forces acting on the object, and forces due to attaching and/or affixing of at least one end of cord to external entity (e.g., ear-bud in user's ear for headphone cord). The malleability of the cord may also aid in the frictional retention of the object on the cord.

Objects in accordance with the present invention may be used to retain many different types of cords to create ornamental effects. Cords may be comprised of a single filament or multiple filaments together. Cords may be headphone cords, as used in canonical examples herein. Cords may be embodied by multiple strands of hair (such as locks, bundles, dreadlocks, tresses, curls, braids, string-wraps, and/or ringlets) aggregated or arranged or coordinated to allow retention by the object. Cords may also be embodied by shoelaces, shoestrings, and/or bootlaces, as used in footwear such as sneakers, shoes, or boots. Cords may be embodied by drawstrings, as used in clothing (such as jackets, hooded sweatshirts, pajamas, scrubs, and/or tracksuits) or bags (pouches, sleeping bags, stuff sacks, and/or backpacks). Cords may be embodied by various types of strings or other materials used to prevent helium balloons from floating away.

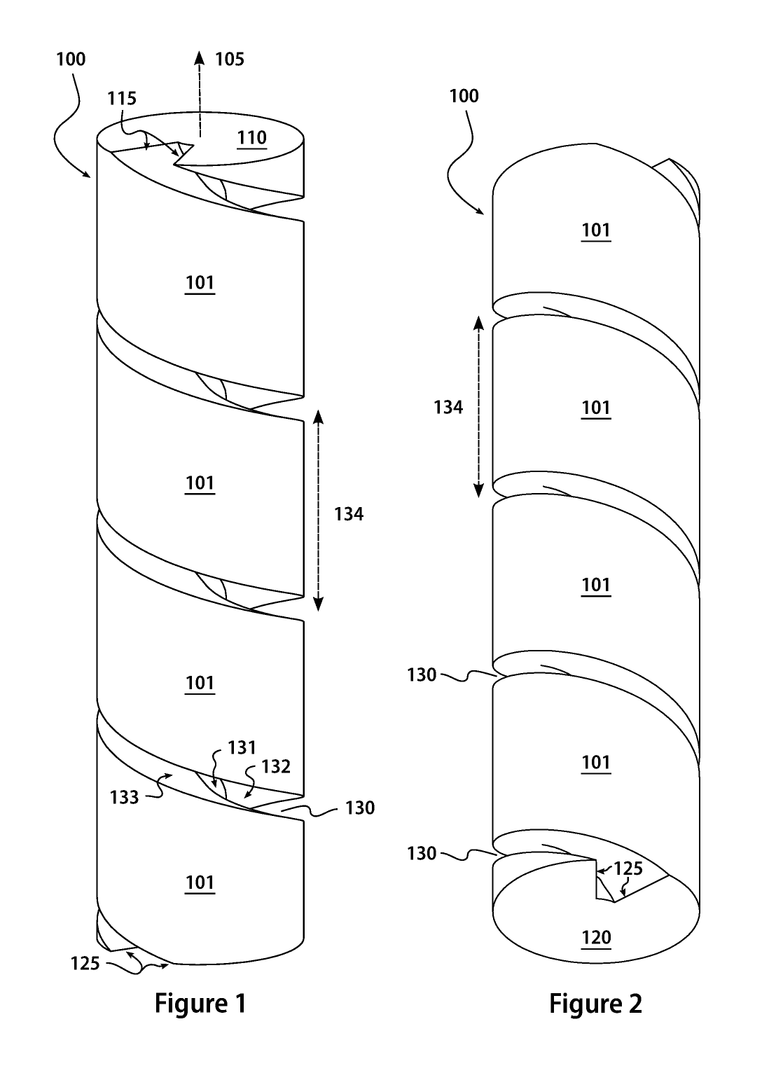

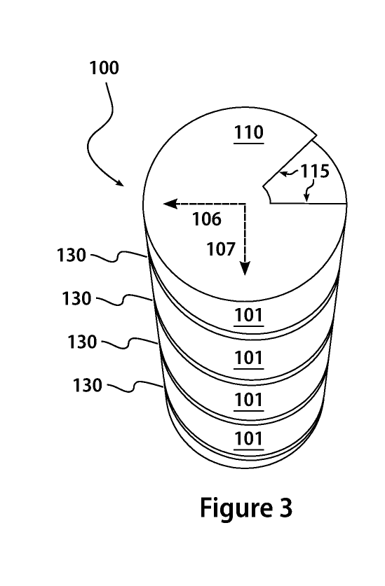

FIGS. 1, 2, and 3 show one example of a decorative object 100 in accordance with the present invention. The example of FIGS. 1, 2, and 3 illustrates a cylindrical object 100 having a first axis 105 extending along the length of the cylinder, and, in the present example, extending perpendicularly to a first circular face 110 and a second circular face 120 defining the opposing ends of the cylindrical object 100. The example of FIGS. 1, 2, and 3 further illustrates second axis 106 and third axis 107, which are perpendicular to first axis 105, to each other, and to tangents along the edges of first circular face 110 and second circular face 120. A lateral exterior surface 101 of the object 100 has a groove 130 formed into surface 101 to receive the headphone cord and to frictionally retain the object 100 on the headphone cord within the groove. Groove 130 winds in helical fashion from first end of object 100 (corresponding to first circular face 110) to second end of object 100 (corresponding to second circular face 120). Groove 130 may extend in a regular helical fashion having a spacing distance 134, but may have a spacing or pitch that varies along axis 105. Groove 130 may have first terminal end 115 in first circular face 110, and second terminal end 125 in second circular face 120. A headphone cord may be inserted into the groove 130 beginning at either terminal end 115 or 125 of groove 130 and then wound into groove 130 along first axis 105 of object 100, thereby affixing the decorative object 100 to the headphone cord. In other examples, however, a cord may be inserted initially at any location along one or more groove provided on the surface of an object in accordance with the present invention.

The geometric relationship between the first axis 105 of object 100 and the headphone cord may contribute to the frictional retention of the object on said cord. The portion of the headphone cord not frictionally retained within the groove corresponds to a geometric “pathway” (one or more connected line segments) between the audio device and the headphone. When the headphone and object are worn by the user, the headphone cord may be under tension due to gravitational and other forces, and this cord pathway may be mathematically approximated by a line. The angle between the first axis 105 of object 100, and the line approximating the pathway of headphone cord under tension, may be relatively small under typical usage (for example, ranging from 0-40°), such that first axis 105 is substantially parallel to the cord pathway. The specific angular measure may depend upon the particular shape of object 100, the terminal ends 115,125 in circular faces 110,120, lateral exterior surface 101, groove 130, and/or other aspects of design and implementation of the object, as well as individual user preferences in affixing the object to the headphone cord.

In the example of FIGS. 1, 2, and 3, the lateral exterior surface 101 may present a continuous surface that may be used as a canvas upon which ornamentation may be placed. However, ornamentation may also be part of, affixed to, or placed elsewhere on object 100, such as within all or part of groove 130, the first circular face 110, and/or the second circular face 120. Further, the lateral exterior surface (or other portion of object used as a canvas for ornamentation) need not be continuous and unbroken. Further, more than a single groove 130 may be used, for example to provide multiple options for frictionally retaining a cord, to potentially retain a second cord, or for other purposes.

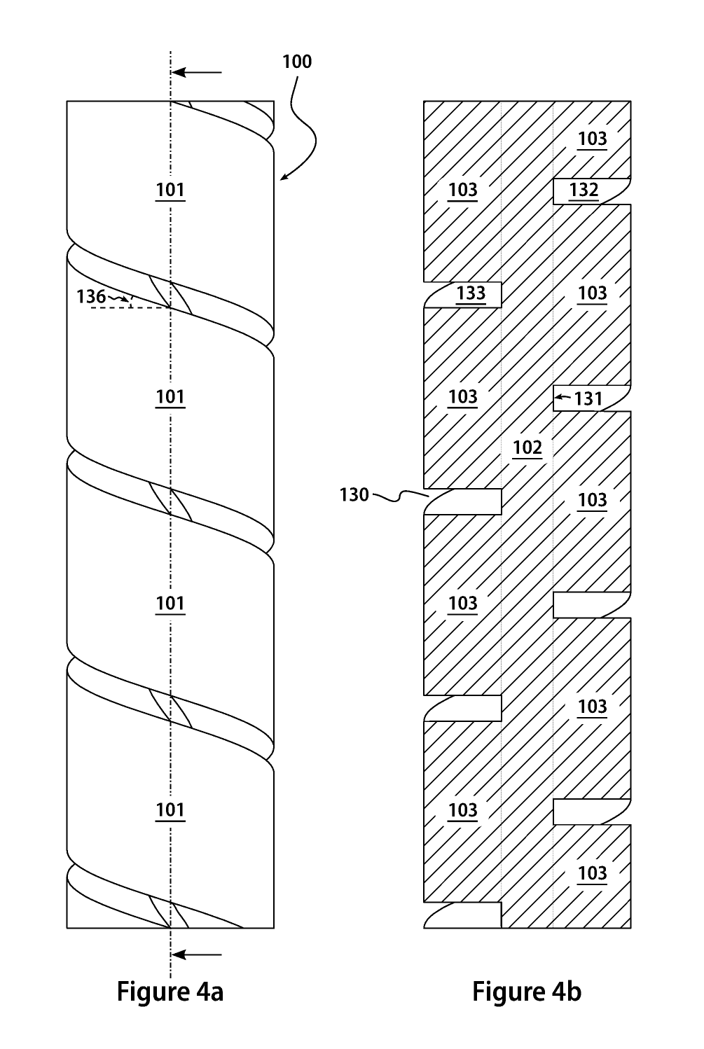

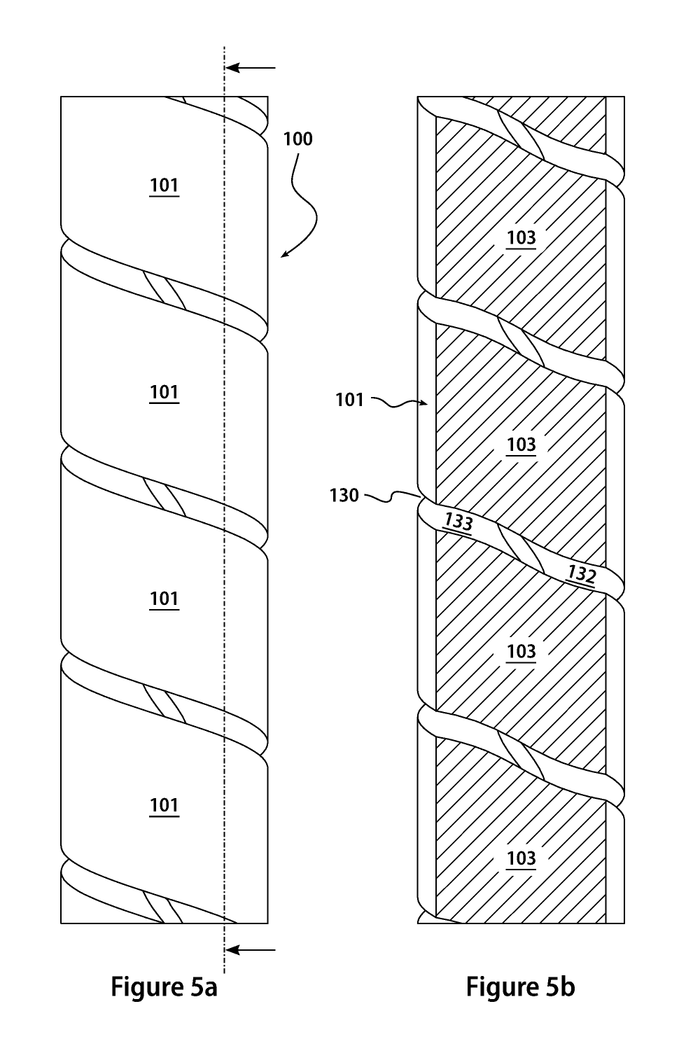

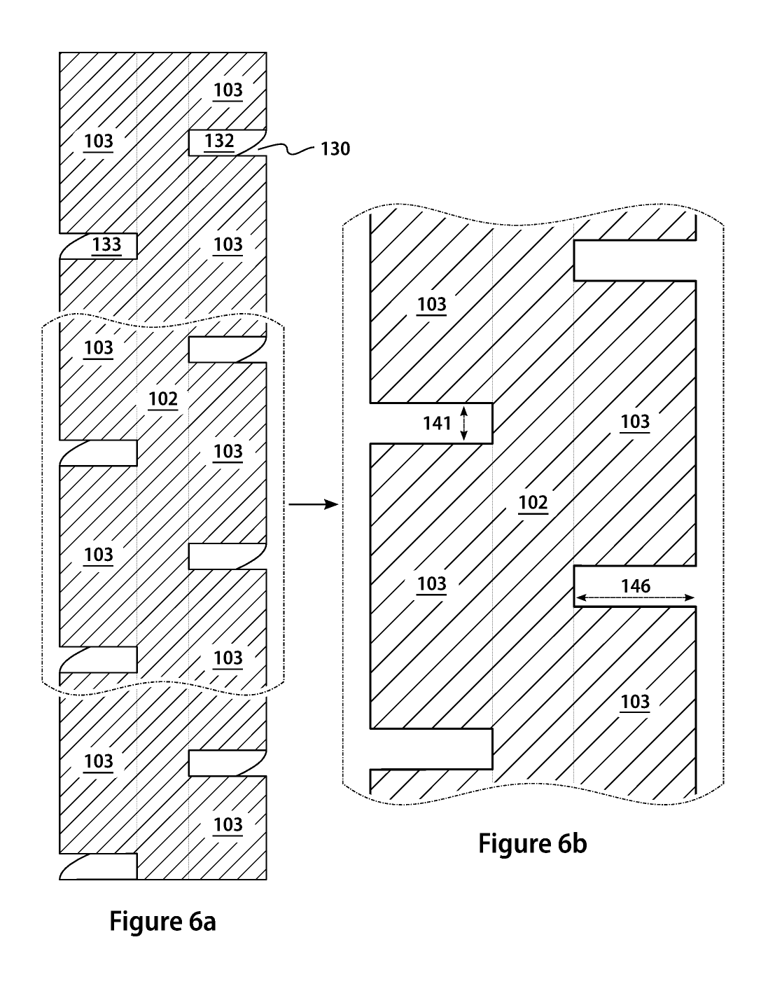

Referring to the example of FIGS. 4a, 4b, 5a, 5b, 6a, and 6b, a groove 130 may be formed in a spiral or helical fashion around the axis 105 into the exterior lateral surface 101 of the object 100. Accordingly, groove 130 may have a pitch 136 that determines (along with the length of object 100) the number of groove turns made along the length of an object 100 from a first end corresponding to a first face 110 to a second end corresponding to a second face 120. Pitch 136 may be determined by spacing between periodic repetitions of base unit of helix along first axis 105. Depending upon the length of the object 100, the diameter of the object core 102 of the object 100 (which may vary along the length of the object 100), the width 141 and depth 146 of groove 130, the shape of the exterior lateral surface 101, any potential additional decoration of the object 100, as well as possible other factors, different values of groove pitch 136 may be chosen, that correspond to different numbers of turns of the groove 130 that may be formed within the exterior lateral surface 101 of the object 100. The number of turns desired for any particular example of the present invention may vary based upon the weight of the decorative object 100, the material or manufacturing methods of the decorative object 100, the anticipated frictional forces between a cord and the groove 130, and/or the desired aesthetic presentation of the object 100.

As shown in the example of FIGS. 1, 4a, 4b, 5a, 5b, 6a, and 6b, a groove 130 may have width 141 and depth 146, as defined by first sidewall 132, second sidewall 133, and floor 131 of groove 130. A cord may be retained within groove 130. First sidewall 132, second sidewall 132, and floor 131 of groove 130 need not be planar, nor need they have stepped or regular construction or appearance. While in many examples, objects in accordance with the present invention may provide a groove 130 having a uniform width 141, depth 146, and/or pitch 136, the width, depth, and/or pitch of a groove may be varied along the length of an object in accordance with the present invention. In some examples, this variation of pitch, width, and/or depth may itself provide a decorative or aesthetically pleasing component to an object 100 in accordance with the present invention. In some examples, a uniformity of pitch, width, and/or depth may itself comprise a decorative element to an object 100 in accordance with the present invention. The groove 130 may also vary in shape, size, material, ornamentation, or other aspects.

As depicted in the example of FIGS. 4a, 4b, 5a, 5b, 6a, and 6b, the internal components of object 100 may include object core 102 and object interior 103. Object core 102 comprises the object portion or portions with coordinate positions less than that of groove floor 131, along second axis 106 and third axis 107 of the object, at a given coordinate position of first axis 105 of the object. Alternatively, when the object is viewed in cross section along first axis 105, object core 102 comprises the object portion or portions not intersected by groove 130. The surface of object core 102 may be comprised of the groove floor 131 and portions of the first circular face 110 and the second circular face 120. The object interior 103 may be defined as all internal portion or portions of object 100 not included as part of object core 102. The surface of the object interior may be comprised of object surface 101, groove first sidewall 132, groove second sidewall 133, and portions of first circular face 110 and second circular face 120.

The dimensions of an object and the component parts of such an object in accordance with the present invention, such as the example object 100 and its elements as illustrated in FIGS. 1, 2, 3, 4a, 4b, 5a, 5b, 6a, and 6b, may vary based upon ornamental designs, user preferences, the size, shape, and type of cord to be engaged and frictionally retained, etc. In some examples, however, object 100 may have a range of lengths (along first axis 105) such as 40-100 mm or 25-150 mm; a range of diameters of the first circular face 110 and the second circular face 120 (diameter within the plane formed by second axis 106 and third axis 107) such as 15-25 mm or 10-75 mm; a range of diameters of the object core 102 such as 5-25 mm or 5-50 mm; a range of groove widths 141 (which may be dependent upon object length, groove pitch, cord diameter, object ornamentation, and/or other factors) such as 2-10 mm or 1-15 mm (e.g., a groove may have a width sufficient to retain an associated cord, such as groove width of 3-5 mm to retain shoelace cord with diameter of 2.5-4 mm); a range of groove depths 146 (which may be dependent upon exterior diameter, interior diameter, and/or other factors) such as 5-15 mm or 2-25 mm; and a range of values of groove spacing 134 between helical grooves (along first axis 105, at given point in plane of second axis 106 and third axis 107) such as 10-20 mm or 4-40 mm In one example, the object may have a length of 80 mm, an exterior diameter (i.e., of the opposing circular faces) of 20 mm, an interior diameter (i.e., of the object core) of 5 mm, a groove width of 2.5 mm, a groove depth of 7.5 mm, and a spacing between helical grooves of 20 mm While the total mass of an object 100 may vary based upon size, shape, design, ornamentation, materials, and other factors, the mass of an object, may, in some cases, be in ranges such as 15-75 g or 5-200 g. In one particular example, the mass of object 100 may be 22 g. The range of diameters of the cord to be frictionally retained by groove 130 of object 100 may vary based upon the type of cord on which the object is affixed. However, in some examples of a headphone cord, the cord may have a range of diameters such as 1.5-2 5 mm or 1-5 mm In some examples of hair locks, tresses, or curls, used as the cord, the cord may have a range of diameters such as 2-5 mm or 1-10 mm, for all filaments in aggregate. In some examples of a shoelace cord, the cord may have a range of diameters such as 2.5-4.5 mm or 1.5-6.5 mm. In some examples of a drawstring, the cord may have a range of diameters such as 5-7 mm or 3-9 mm In some examples of a balloon string, the cord may have a diameter such as 2-5 mm or 1-8 mm If the cord is asymmetric, rather than circular in cross-section, dimensional ranges may encompass both narrower and/or wider linear dimensions of cross-section. Irrespective of these examples, the dimensions, mass, and other properties of an object, as well as those of a cord, may vary from these examples.

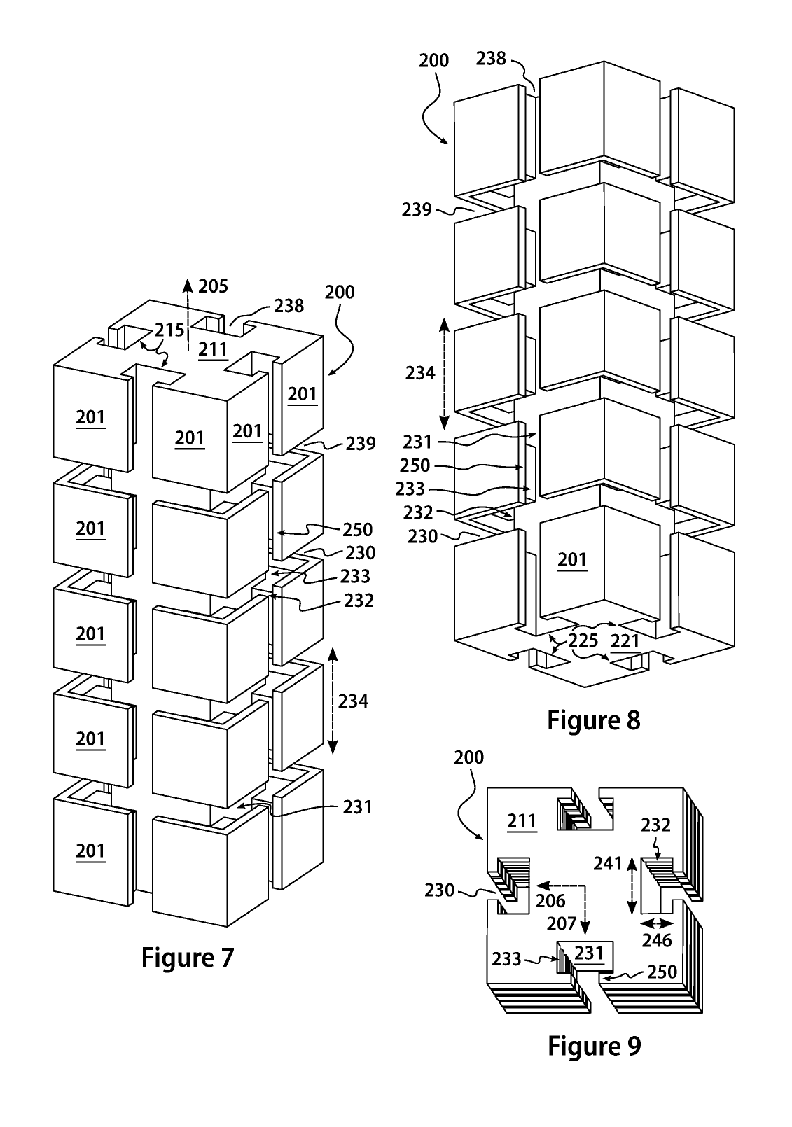

FIGS. 7, 8, and 9 show another example of a decorative object 200 in accordance with the present invention. The example of FIGS. 7, 8, and 9 illustrates a right-square prismatic object 200 having a first axis 205 extending along the length of the prism, and, in the present example, extending perpendicularly to a first square face 211 and a second square face 221, defining the opposing ends of the prismatic object 200. The example of FIGS. 7, 8, and 9 further illustrates the second axis 206 and third axis 207, which are perpendicular to first axis 205, to each other, and to edges of the first square face 211 and second square face 221. The first square face 211 and second square face 221 (corollaries to the first circular face 110 and second circular face 120 of FIGS. 1-3) each feature multiple first terminal ends 215 and second terminal ends 225, respectively. A lateral exterior surface 201 of the object 200 has a groove 230 formed into surface 201 to receive the headphone cord and to frictionally retain the object 200 on the headphone cord within the groove. Groove 230 may extend, in regular periodic fashion with spacing distance 234, along first axis 205, second axis 206, and/or third axis 207. Groove 230 terminates in multiple first terminal ends 215 in first square face 211 and in multiple second terminal ends 225 in second square face 221. A headphone cord may be inserted into the groove 230 at any one of multiple first terminal ends 215 on first square face 211 or at any one of multiple second terminal ends 225 on second square face 221, and then may be wound into groove 230 of object 200, thereby affixing the decorative object 200 to the headphone cord. In other examples, however, a cord may be inserted initially at any location along one or more groove provided on the surface of an object in accordance with the present invention.

As illustrated in the example of FIGS. 7, 8, and 9, groove 230 may be comprised of a first plurality and a second plurality of grooves. The first plurality of grooves 238 may be aligned with the first axis 205 of object 200. The second plurality of grooves 239 may be aligned with the plane defined by the second axis 206 and the third axis 207 of object 200. Each groove in the first plurality of grooves 238 may be represented as a line (mathematically: may be represented as an “open polygonal chain”), terminating in one of multiple first terminal ends 215 on first square face 211, and in one of multiple second terminal ends 225 on second square face 221. Each groove in second plurality of grooves 239 may be represented as a loop (mathematically: may be represented as a “closed polygonal chain”), without termination in any terminal end. Together, both pluralities of grooves create an intersecting pattern of grooves (in the form of a “checkerboard” pattern of object surfaces 201, wrapped around object 200). The set of first and second pluralities of grooves enables multiple distinct groove pathways between one of multiple first terminal ends 215 on first square face 211 and one of multiple second terminal ends 225 on second square face 221. The user or wearer of object 200 may choose, as desired, whichever groove pathway is preferred, such that groove pathway so chosen enables sufficient contact between cord and object to frictionally retain object on cord. The groove pathway may be selected so that successive individual groove segments, comprising the groove pathway, alternately belong to the first plurality of grooves 238 and the second plurality of grooves 239. As so constructed, by alternation between first plurality and second plurality of grooves, groove pathway may enable cord to wrap around object one or more times to frictionally retain object on cord. Such a selection of the groove pathway may resemble a “discretized” helical pathway. In contrast to the (non-discretized) helical groove 130 (from FIGS. 1, 2, 3, 4a, 4b, 5a, 5b, 6a, and 6b), discretization implies that, for neighboring positions along groove pathway, positional coordinates of said groove pathway do not simultaneously change along first axis 205 of object 200, and within plane defined by second axis 206 and third axis 207 of object 200. Instead, the change in positional coordinates of said groove pathway may alternate between being constrained along first axis 205 of object 200, and being constrained within plane defined by second axis 206 and third axis 207 of object 200.

In the example of FIGS. 7, 8, and 9, the lateral exterior surface 201 may present a noncontinuous surface, separated by intersections of the first plurality of grooves 238 and the second plurality of grooves 239, that may be used as a canvas upon which ornamentation may be placed. However, ornamentation may also be part of, affixed to, or placed elsewhere on object 100, such as within all or part of the first plurality of grooves 238 and the second plurality of grooves 239, and/or on all or part of the first square face 211 and the second square face 221.

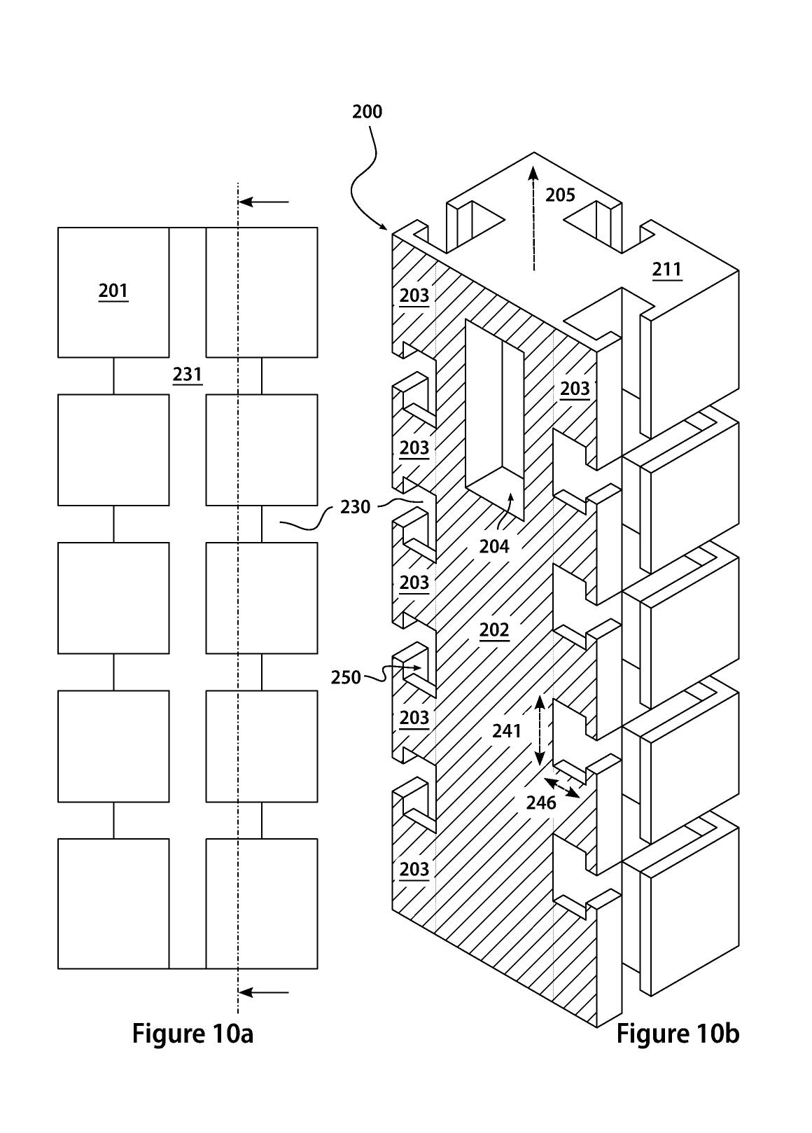

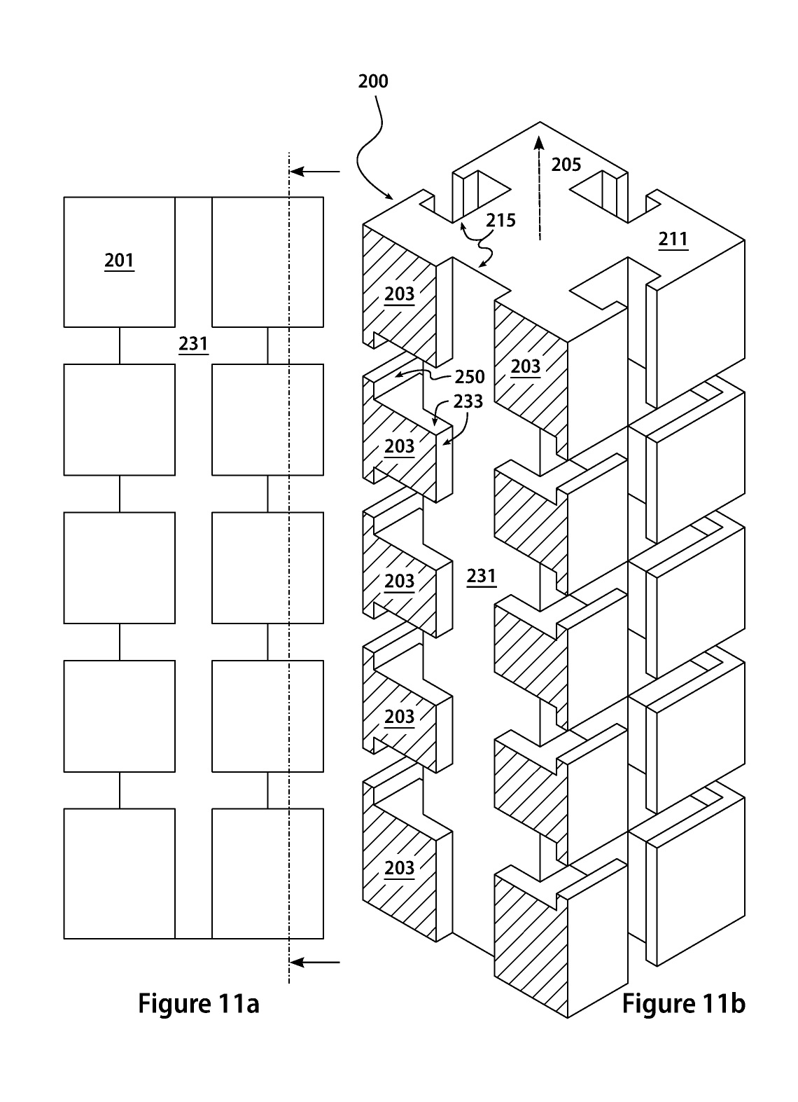

Referring to the example of FIGS. 7, 10a, and 10b, a groove 230 may have width 241 and depth 246, as defined by first sidewall 232, second sidewall 233, and floor 231 of groove 230. Groove may have lips 250 laterally extending from object surface 201 a fractional amount of overall groove width 241. A cord may be retained within groove 230. First sidewall 232, second sidewall 233, floor 231, and lips 250, of first plurality of grooves 238 and second plurality of grooves 239 need not be planar, nor need they have stepped or regular construction or appearance. While in many examples, objects in accordance with the present invention may provide first plurality of grooves 238 and second plurality of grooves 239 having uniform width 241, depth 246, spacing 234, first sidewall 232, second sidewall 233, floor 231, and lips 250, the width, depth, spacing, first sidewall, second sidewall, floor, and lips of groove may be varied within or between first plurality of grooves 238 and second plurality of grooves 239, in accordance with the present invention. In some examples, this variation of width, depth, and/or spacing may itself provide decorative or aesthetically pleasing component to object 200 in accordance with present invention. In some examples, a uniformity of width, depth, and/or spacing may itself comprise a decorative element to an object 200 in accordance with the present invention. The first plurality of grooves 238 and second plurality of grooves 239 may also vary in shape, size, material, ornamentation, or other aspects.

As depicted in the example of FIGS. 10a, 10b, 11a, 11b, 12a, 12b, and 12c, the internal components of object 200 may include object core 202 and object interior 203. Object core 202 comprises the object portion or portions with coordinate positions less than that of groove floor 231, along the second axis 206 and third axis 207 of the object, at a given coordinate position of the first axis 205 of the object. Alternatively, when the object is viewed in cross section along first axis 205, object core 202 comprises the object portion or portions not intersected by groove 230. The surface of object core 202 may be comprised of the groove floor 231 and portions of the first square face 211 and the second square face 221. The object interior 203 may be defined as all internal portion or portions of object 200 not included as part of object core 202. The surface of the object interior may be comprised of object surface 201, groove first sidewall 232, groove second sidewall 233, and portions of first square face 211 and second square face 221.

As illustrated in the example of FIGS. 10a, 10b, 12a, 12b, and 12c, the decorative object 200 may have an object cavity 204 as an internal void within the object core 202, in accordance with the present invention. Object cavity 204 may be shaped as a rectangular prism, but it also may be constructed of other shapes as well as various sizes. One or more cavities may be situated within the object core 202 (as shown in associated figures), within the object interior 203, or within both object core 202 and object interior 203. The size and shape of the object cavity 204, as well as its existence, may be determined by various factors, including but not limited to: reducing the mass of object 200 to potentially increase comfort during use, or to potentially save material costs during manufacturing; changing, and otherwise optimizing through engineering, the center-of-mass and/or moments-of-inertia of object 200 in order to better determine orientation of display of object, and movement of object (six degrees-of-freedom via translation and rotational orientation); engineering specific attributes of object 200 in categories to include, but not be limited to, acoustical, chemical, electrical, financial, magnetic, manufacturing, mechanical, optical, supply-chain management, sustainability, and thermal properties; providing space within object 200 to position additional engineered components to control kinematic motion, light sources, audio sources, audio receivers, and/or heat sources that contribute to overall use of object 200; creating a user-accessible compartment within object 200 for optional user storage of appropriately sized and shaped items (with access to compartment through user-removable and/or user-replaceable portion or portions of object surface, object interior, and/or object core); and contributing to ornamental or decorative presentation of object 200.

The dimensions of an object and the component parts of such an object in accordance with the present invention, such as the example object 200 and its elements as illustrated in FIGS. 7, 8, 9, 10a, 10b, 11a, 11b, 12a, 12b, and 12c, may vary based upon ornamental designs, user preferences, the size, shape, and type of cord to be engaged and frictionally retained, etc. In some examples, however, object 200 may have a range of lengths (along first axis 205) such as 40-100 mm or 25-150 mm; a range of dimensional widths and depths of the first square face 211 and second square face 221, such as 15-30 mm or 10-75 mm; a range of dimensional widths and depths of object core 202 such as 5-25 mm or 5-50 mm; a range of groove widths 241 for first plurality of grooves 238 and second plurality of grooves 239 (which may be dependent upon object length, dimensions of object interior and object core, dimensions of first and second square faces, groove spacing, dimensions of groove lips, headphone-cord diameter, object ornamentation, and/or other factors) such as 4-10 mm or 2-20 mm; a range of groove depths 246 for first plurality of grooves 238 and second plurality of grooves 239 (which may be dependent upon dimensions of object interior and object core, and/or other factors) such as 5-15 mm or 1-20 mm; a range of dimensional values of groove lips 250 for first plurality of grooves 238 and second plurality of grooves 239 (which may be dependent upon dimensions of object interior, object core, groove width, and groove depth, and/or other factors) such as 2-5 mm or 1-10 mm; and a range of values of groove spacing (along first axis, at given point in plane of second axis and third axis) such as 10-20 mm or 5-50 mm In one particular example, the object may have a length of 80 mm, dimensions of square faces of 28 mm, dimensions of (square) object core of 16 mm, a groove width of 8 mm, a groove depth of 6 mm, dimensions of groove lips of 2 mm, and a spacing between grooves of 16 mm. While the total mass of an object 200 may vary based upon size, shape, design, ornamentation, materials, and other factors, the mass of an object, may, in some cases, be in the ranges of 20-80 g or 5-200 g. In one particular example, the mass of object 200 may be 40 g. The range of diameters of the cord to be frictionally retained by groove 230 of object 200 may vary based upon the type of cord on which the object is affixed. However, in some examples of a headphone cord, the cord may have a range of diameters such as 1.5-2.5 mm or 1-5 mm In some examples of hair locks, tresses, or curls, used as the cord, the cord may have a range of diameters such as 2-5 mm or 1-10 mm, for all filaments in aggregate. In some examples of a shoelace cord, the cord may have a range of diameters such as 2.5-4.5 mm or 1.5-6.5 mm In some examples of a drawstring, the cord may have a range of diameters such as 5-7 mm or 3-9 mm. In some examples of a balloon string, the cord may have a diameter such as 2-5 mm or 1-8 mm If the cord is asymmetric, rather than circular in cross-section, dimensional ranges may encompass both narrower and/or wider linear dimensions of cross-section. Irrespective of these examples, the dimensions, mass, and other properties of an object, as well as those of a cord, may vary from these examples.

Objects in accordance with the present invention may have varying sizes and shapes. An object in accordance with the present invention may comprise any type of 3-dimensional (3D) solid, either filled or with one or more internal voids or cavities. As described in some examples above with regard to FIGS. 1, 2, 3, 4a, 4b, 5a, 5b, 6a, 6b, 7, 8, 9, 10a, 10b, Ila, 11b, 12a, 12b, and 12c, and as described further in additional examples below, an object in accordance with the present invention may comprise or take the shape of a right cylinder, a right square prism, or a right hexagonal prism, an elongated object with underlying cross-sectional shape of non-polyhedral kidney, or a rotationally-distorted frustum (truncated cone) with elliptical cross-section. Other base shapes, configurations, and topologies of a decorative object may be used within the scope of the present invention, such as, including, but not limited to, a cone, pyramid, sphere, and ellipsoid. By way of further example, the object need not be cylindrical or prismatic at all, need not involve right angles, need not include two (or even one) terminal ends, and need not even include an exterior lateral surface with flat faces, straight edges and/or sharp corners or vertices.

The design of the object may also, and/or alternatively, be considered from a mathematical perspective, using the language and terminology of geometry. The object may vary in size, dimensions, and/or shape. It may be formulated as a true 3D shape (that may include some or all of interior of object) and/or as a 2D closed surface embedded within a 3D Euclidean space (e.g., mathematically, this refers to the difference between a ball and a sphere, respectively). The object may be a polyhedron (3-polytope), non-polyhedron, or combination or aggregation of one or more polyhedral and non-polyhedral shapes. The object, or one or more components of the object, may be represented, partially or wholly, as a polyhedron that is some realizable combination of: simple or self-intersecting; convex or non-convex; orientable or non-orientable; regular, quasi-regular, semi-regular, or non-regular. The object, or one or more components of the object, may possess, partially or wholly, various measures of: equality; symmetry; congruence; similarity; isotopy. A non-polyhedral object, or one or more non-polyhedral components of the object, may be created via application of homeomorphisms to any polyhedral object, or to one or more polyhedral components of the object. (The mathematical lay-definition of homeomorphism is the continuous stretching and bending of an object into a new shape; an example is that a square can be converted to a circle via application of homeomorphisms, while a ball cannot be turned into a donut [mathematically, a “torus”] by application of homeomorphisms since the donut hole requires a non-continuous “breaking” of the ball.) The object, or one or more components of the object, may be represented by various parametric equations to mathematically describe said 3D solid or 2D closed surface; varying the set of parameters associated with these equations may allow for the selection of different particular shapes for the object from among a family of such shapes. For example, the object, or one or more components and/or base shapes of the object, may be a member of the set including, but not limited to: Platonic solids; Archimedean solids; Catalan solids; Johnson solids; conic solids; truncated hyperboloids (of one sheet); and truncated paraboloids.

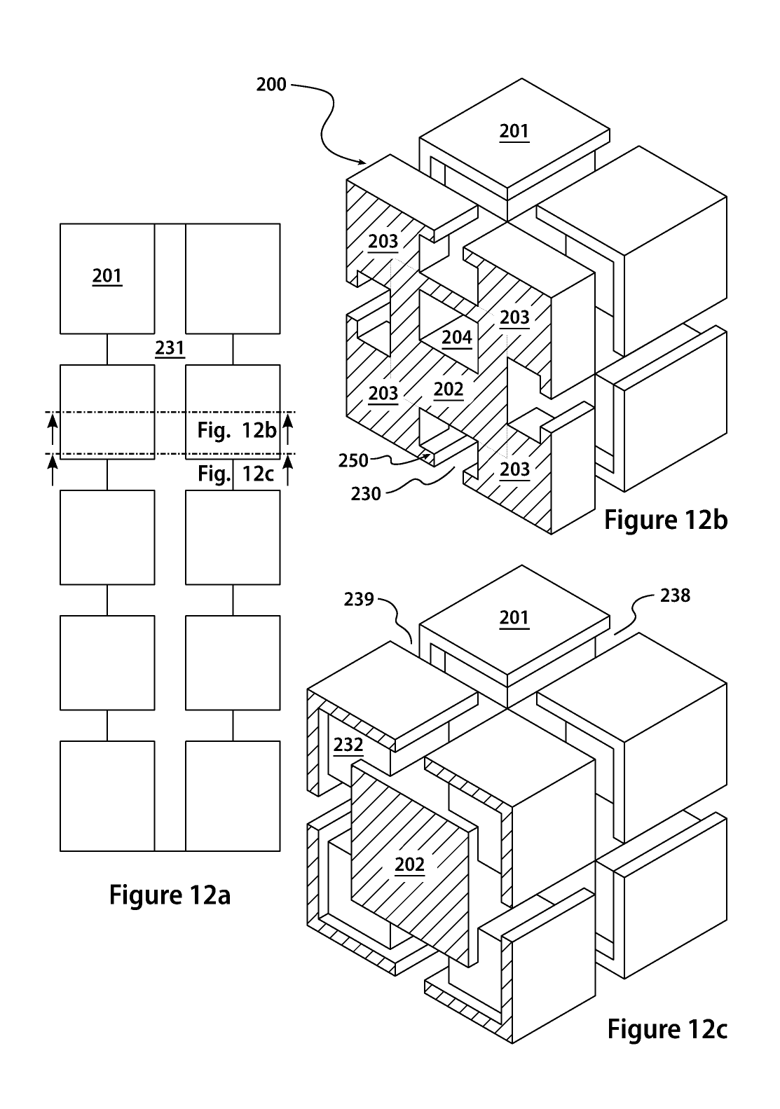

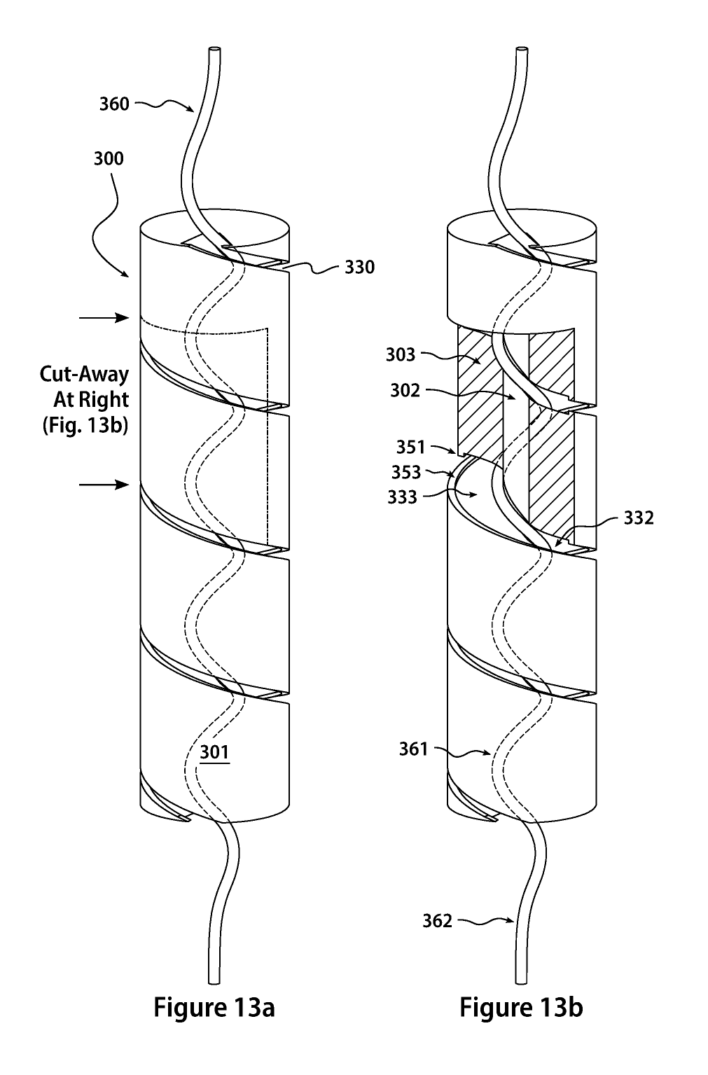

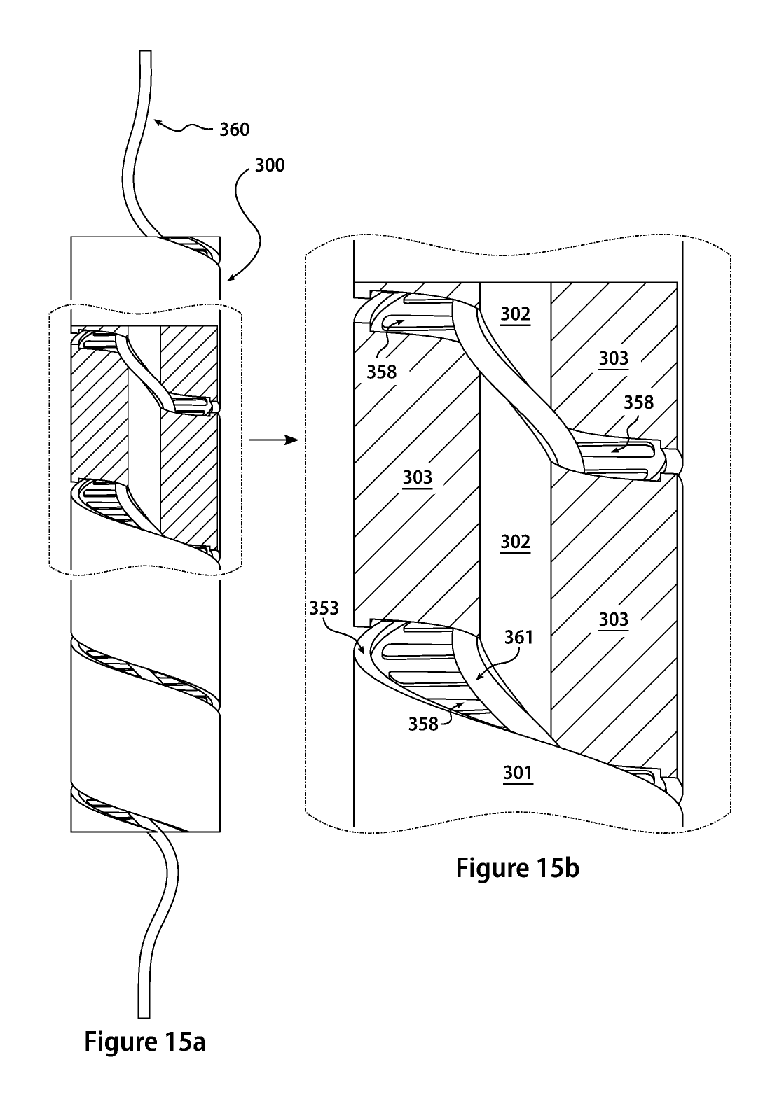

As illustrated in FIGS. 13a, 13b, 14a, 14b, 15a, and 15b, the groove 330 of an object 300, in accordance with the present invention, may comprise an indentation or channel configured in at least a portion of the object surface 301, and/or recessed into at least a portion of the object interior 303. Groove 330 may receive the headphone cord 360 and retain the cord within the indentation. One or more contiguous portions of the overall cord 360 may be retained within groove 330 and termed as retained cord 361, serving to affix object 300 to cord 360 via frictional retention within groove 330, while the remainder of cord 360 is external cord 362, not in frictional contact with groove 330. The indentation or channel may comprise a groove that extends around a perimeter of the object, the groove frictionally retaining the headphone cord within itself to affix the object to the cord.

The groove 330 used to receive a cord 360 may extend in a helical or spiral fashion on/in the surface of the object. It may possess various helical angles, and its helical orientation may be right-handed or left-handled with respect to its axis. Other patterns may be used. For example, a groove may be provided in the lateral surface 301 of an object (which, as described in some examples above with regard to FIGS. 1, 2, 3, 4a, 4b, 5a, 5b, 6a, 6b, 7, 8, 9, 10a, 10b, 11a, 11b, 12a, 12b, and 12c, and as described further in additional examples below, may be comprised of a right cylinder, a right square prism, a right hexagonal prism, an elongated object with an underlying cross-sectional shape of a non-polyhedral kidney, or a rotationally-distorted frustum [truncated cone] with an elliptical cross-section), extending in a number of helical- or spiral-like manifestations, so as to include, but not be limited to, the helicoid, the elliptical helicoid, the generalized helicoid, the hemihelix surface, and others. Further, a groove may be formed, partially or completely, within and/or through a portion of the object that extends from other portions of the surface of the object, for example by forming a hook-like extension providing a groove to frictionally retain a cord. Further, a groove of whatever pattern or structure need not be continuous, as a cord may be frictionally retained in multiple shorter grooves.

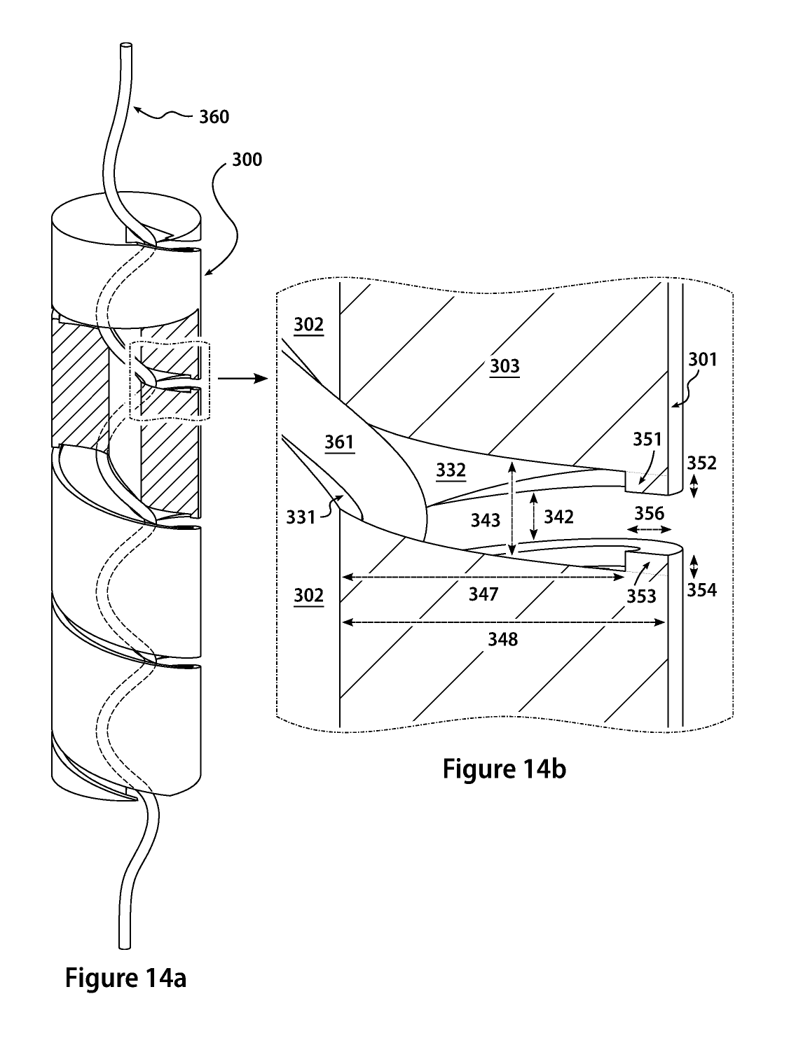

While FIGS. 13a, 13b, 14a, and 14b illustrate an example of a groove 330 with flat walls and floor, in other examples in accordance with the present invention, shapes or textures 358 may be provided on or in the surface(s) of the walls and/or floor of a groove. Such texture may comprise polygonal or non-polygonal two-dimensional or three-dimensional shapes 358 affixed to groove first sidewall 332, groove second sidewall 333, and/or groove floor 331. Groove floor and/or groove sidewall surfaces may be modified by application of patterns 358 and/or of periodic texturing 358. Groove texture 358 may alter the frictional forces between groove 330 and retained cord 361; frictional forces may be effected by the height or depth of affixed shapes, by the sharpness of the edges of affixed shapes, and/or by the roughness of texturing or patterns. Groove texture 358 may also change the visual appearance of the retained cord within the groove and/or may function in a decorative capacity, even in absence of retained cord, for the groove floor and/or groove sidewalls. For example, large bumps or other protrusions on the floor of a groove 330 may cause a retained cord 361 to visibly undulate within the groove 330. Even if the position of the cord within the groove 330 is not visibly changed, the small bumps, nubs, treads, and/or other textural elements may be added to a groove 330 in order to obtain a desired degree of frictional contact between a groove and a cord in accordance with the present invention.

As depicted in FIGS. 13a, 13b, 14a, 14b, 15a, and 15b, the dimensions and parameters of a decorative object for attachment to a headphone cord and one or more groove provided to receive and frictionally retain the cord and thereby affix the decorative object to the headphone cord may be varied in accordance with the present invention. For example, a groove 330 may have a width 341 and a depth 346, either or both of which may vary. Further, groove first sidewall 332, groove second sidewall 333, and/or groove floor 331 may vary in shape and dimensions and need not be flat, nor need they have a stepped construction. The width 341 and the depth 346 may be selected to receive and frictionally retain a headphone cord based upon the anticipated or known diameter and/or physical properties of the cord 360 to be engaged into the groove 330. For example, width 341 of the groove 330 may be roughly the anticipated diameter of a headphone cord, while depth 346 may be greater than the anticipated diameter of a headphone cord, such that, when a cord is inserted into the groove 330, pressure may be applied to the cord to engage the cord within groove 330 until the cord contacts object core 302 of the decorative object 300, leaving the cord fully inserted into groove 330 and below the corresponding surface 301 of the object 300.

Referring still to the example of FIGS. 13a, 13b, 14a, 14b, 15a, and 15b, in some instances an object in accordance with the present invention may provide a groove 330 having protrusions or “lips” 351,353 extending from the opposing walls at the opening of groove 330. The first lip 351 and the second lip 353 may help retain a cord 361 within groove 330 after sufficient force has been applied to the cord to force it past lips 351,353 and into groove 330. For example, a first lip 351 and a second lip 353 may be located at the entry to groove 330. The first and second lips may have widths 352,354, respectively, as well as depth 356. Lips may have different lip widths 352,354, which may demarcate lip opening. Lip opening may define groove interior width 342, where groove total width 343 is sum of groove interior width (lip opening) 342 and first lip width 352 and second lip width 354. Lips may have different lip depths 356. Lip depth may define groove interior depth 347, where groove total depth 348 is sum of groove interior depth 347 and lip depth 356.

While the example of FIGS. 13a, 13b, 14a, 14b, 15a, and 15b depicts both a first lip 351 and a second lip 353 having symmetrical size and shape, only a single lip, or no lips at all, may be used. Further, lips may vary in shape, dimension, materials, and/or engineered properties along given groove and/or groove sidewalls. Lips need not be symmetrically applied to all grooves and/or groove sidewalls. Individual grooves and/or groove sidewalls might have differentiated lips; such lips might possess differentiated characteristics to include, but not to be limited to: varying shape, varying dimensions, varying pigmentation, varying texture, different materials, and/or distinct engineered properties. Further, any lip provided in accordance with the present invention may have different shapes than those depicted in the example of FIGS. 13a, 13b, 14a, 14b, 15a, and 15b, such as, for example, a more rounded shape, rather than a more angular shape. In some examples, any lip provided may be formed of a material different from the material used to form the decorative object and/or the exterior lateral surface of the object. For a further example in accordance with the present invention, the lip or lips may be composed of a resilient plastic, rubber, or other pliable material (as well as one or more diverse materials, such as described herein) that may be compressed when a cord is inserted into the groove and then may return to its original shape after the cord has been pressed past the lip or lips to retain the cord within the groove until a user applies a force in the opposite direction to extract the cord. Lip design may also be predicated upon and/or integrated with other elements of object design, shape, dimensions, materials, ornamentation, and/or intended usage.

A groove in accordance with the present invention need not be continuous, as the cord may be frictionally retained in multiple shorter groove segments. A groove, or one or more groove segments, may be either linear or non-linear; if non-linear, the groove may have one or more values of curvature and one or more values of torsion. A groove, or one or more groove segments, need not be confined to only one exterior lateral surface. The opening of a groove, or one or more groove segments, need not be at right-angles to the exterior lateral surface. The cross-section of a groove, or one or more groove segments, need not be uniform along a direction normal to cross-section; further, a cross-section of groove, or one or more groove segments, need not by polygonal, nor symmetric. A groove need not be non-branching. Instead, for one or more groove vertices along a groove, three or more groove segments may share the same groove vertex. A groove may be formed as an aggregate of multiple continuous or non-continuous, linear or non-linear groove segments, in which case the selection of a particular groove in which the cord may be frictionally retained can be left to the user of the object upon his or her engagement of the headphone cord. In engaging the cord upon a groove, or one or more groove segments, the user of the object may select to allow some portions of the cord to overlap or cross other portions of the cord, so long as the cord is still frictionally retained on the object. A groove, or one or more groove segments, need not be confined to a single measure of chirality (the mathematical lay-definition of chirality is a property of asymmetry referring to object that is distinguishable from its mirror image, as an example: right- and left-handedness). A groove may exhibit one or more of different possible measures of chirality. If groove segments have different measures of chirality, they may be connected by tendril perversions or other means. A groove, or one or more groove segments, need not be composed of the same material as other components of the object, and instead may may be composed of different materials throughout (e.g., base, walls, lips, or differing along different sections of the groove pathway).

An object in accordance with the present invention may also provide a support-structure to allow the object to independently stand upright. The purpose of said support-structure may be the display and/or storage of the object when not in use or otherwise frictionally retained on a headphone cord; support-structure may maintain the object in a desired orientation on an independent surface (e.g., desk; bookshelf; curio, china, or breakfront cabinet; etc.). The support-structure may be achieved by one or more of: one or more extending members on the object (such as one or more legs or feet); various protrusions on the object; shape of one or more terminal ends of the object; engineered density variations within the object, or engineered placement of one or more cavities, to optimize location of center of mass in relation to the object; flat, quasi-two-dimensional base, extending beyond widest lateral dimension of the object, to provide lateral stability against tipping; relationship between portion of the groove, or one or more groove segments, and the underlying object. The support structure may enable a tilted orientation of the object, such that the object first axis may no longer be normal to the external surface upon which the object is placed. A tilted orientation may enable improved viewing of the object and/or object ornamentation by an observer. The upright orientation of the object, for display and/or storage, can provide both functional and aesthetic benefits, whereby the support-structure may be designed to integrate with the at least one groove and/or terminal ends and may facilitate inserting of cord into groove, wrapping of cord along groove, and frictionally retaining of object on cord within groove.

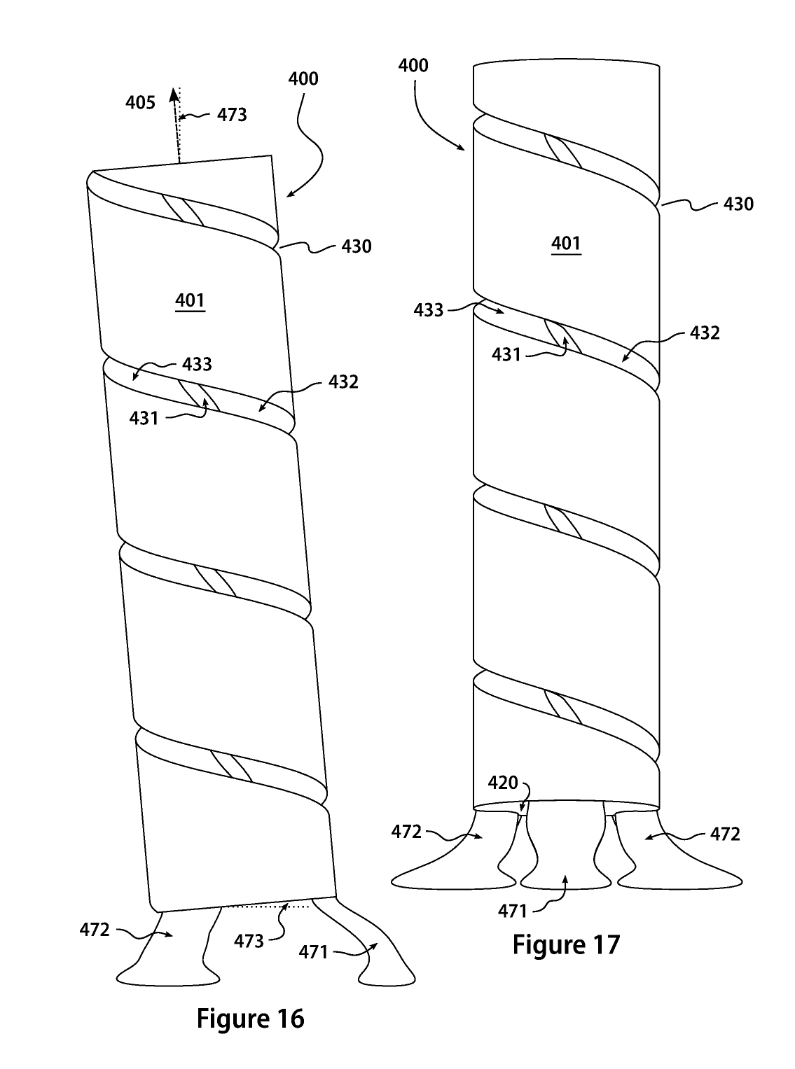

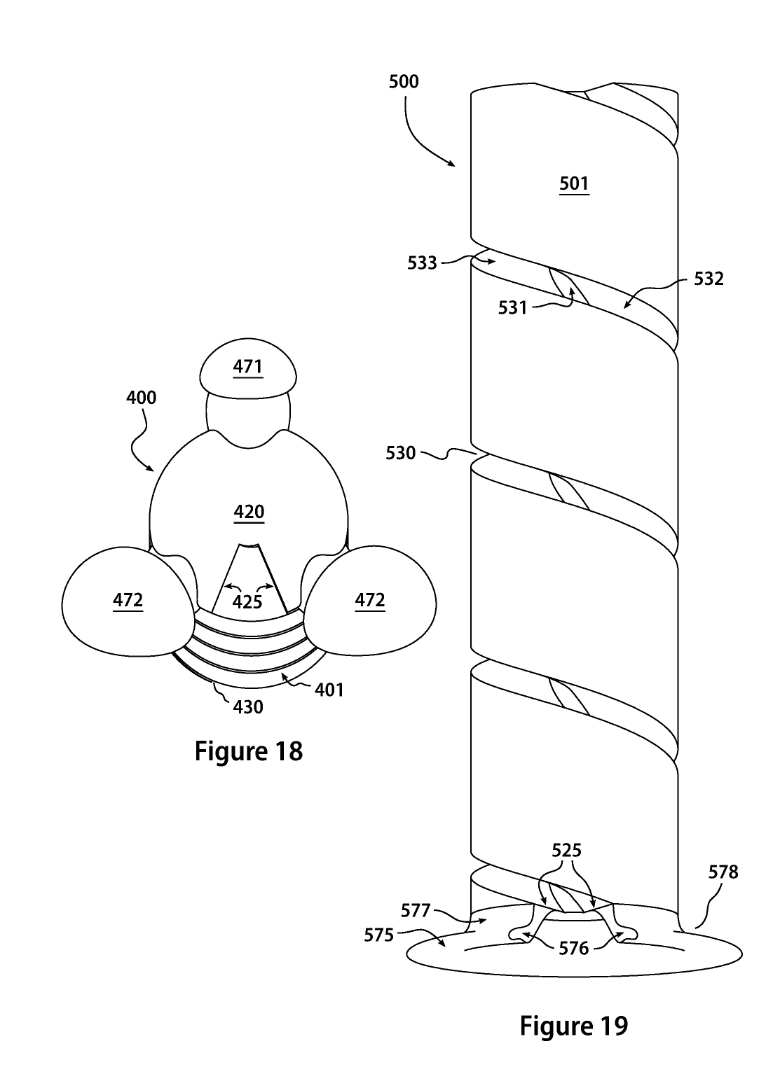

Three examples of support-structures in accordance with the present invention are illustrated in FIGS. 16, 17, 18, 19, 20a, 20b, 21, and 22. FIGS. 16, 17, and 18 illustrate an example of a three-legged (tripod) base that comprises the support-structure of an object 400 in accordance with the present invention. This tripod structure may attach to second circular face 420 of object 400. The tripod structure may comprise one front leg 471 and two rear legs 472; the latter may be positioned on either side of second terminal end 425 of second circular face 420. Together, these legs may provide three non-collinear end-points in contact with an independent surface. Three such endpoints ensure stability as they define a unique planar surface, and which form, when paired with line segments, an equilateral triangle. The relative heights of one front leg 471 and two rear legs 472 may be designed such that object 400 tilts rearward when displayed, with the tilt angle 473 defined between the object first axis 405 and the vector normal to an independent surface upon which the object 400 is supported. Tilt angle 473 may better enable an observer to view the object, including the ornamentation associated with object surface 401 or other parts of object 400. As otherwise described elsewhere herein, object 400 may provide groove 430 (defined by first sidewall 432, second sidewall 433, and floor 431), where groove 430 may receive headphone cord and frictionally retain object on cord within groove 430.

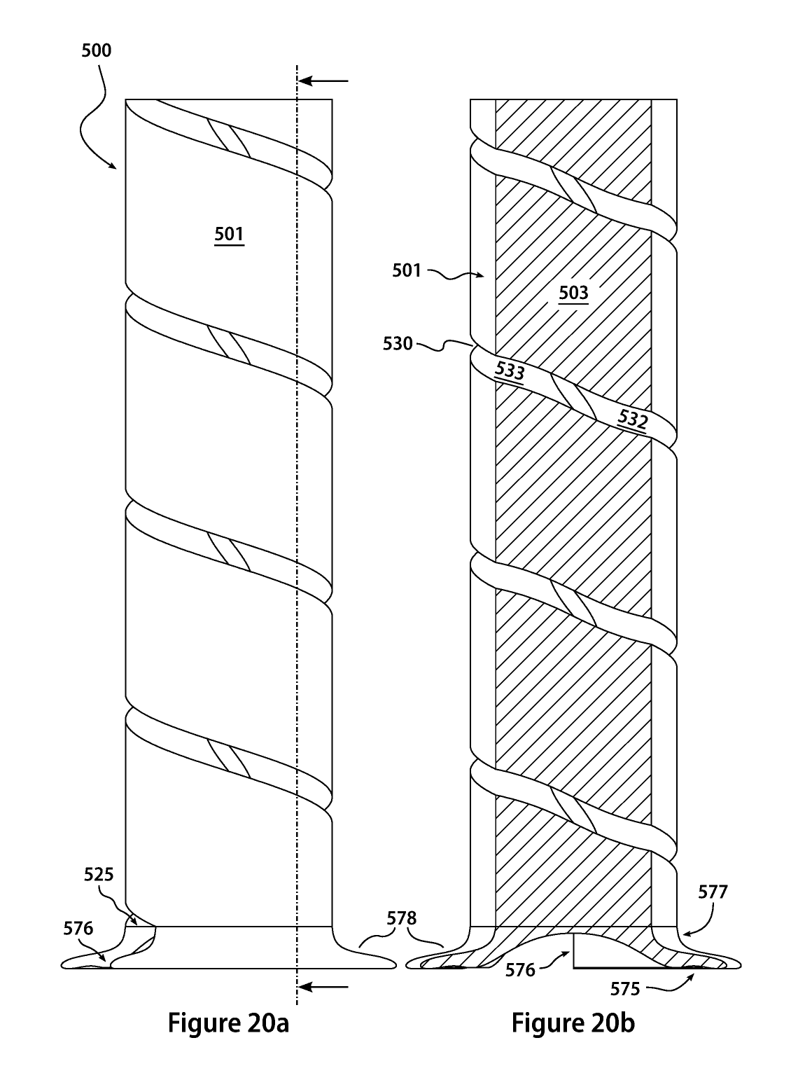

FIGS. 19, 20a, and 20b illustrate an example of a donut-shaped pedestal 578 that comprises the support-structure of an object 500 in accordance with the present invention. Base 575 of pedestal 578 may make contact with an independent surface; base 575 of pedestal 578 may further broaden contact with independent surface, compared with base of object 500 itself, in order to provide a more stable equilibrium against tipping of object 500. Donut-shaped pedestal 578 may comprise both sides 577 (to connect “donut” portion to object) as well as base 575 (to contact independent surface). The interior of pedestal 578 may adjoin interior 503 of object 500. Pedestal 578 may include opening 576 to enable insertion of a cord into second terminal end 525 of object 500. As otherwise described elsewhere herein, second terminal end 525 may provide termination of groove 530 (defined by first sidewall 532, second sidewall 533, and floor 531), where groove 530 may receive headphone cord and frictionally retain object on cord within groove 530. Ornamentation or other decorative aspects may be provided by pedestal 578 (including pedestal base 575 and pedestal sides 577), as well as other portions of object 500, as described elsewhere herein, including, but not limited to, object surface 501.

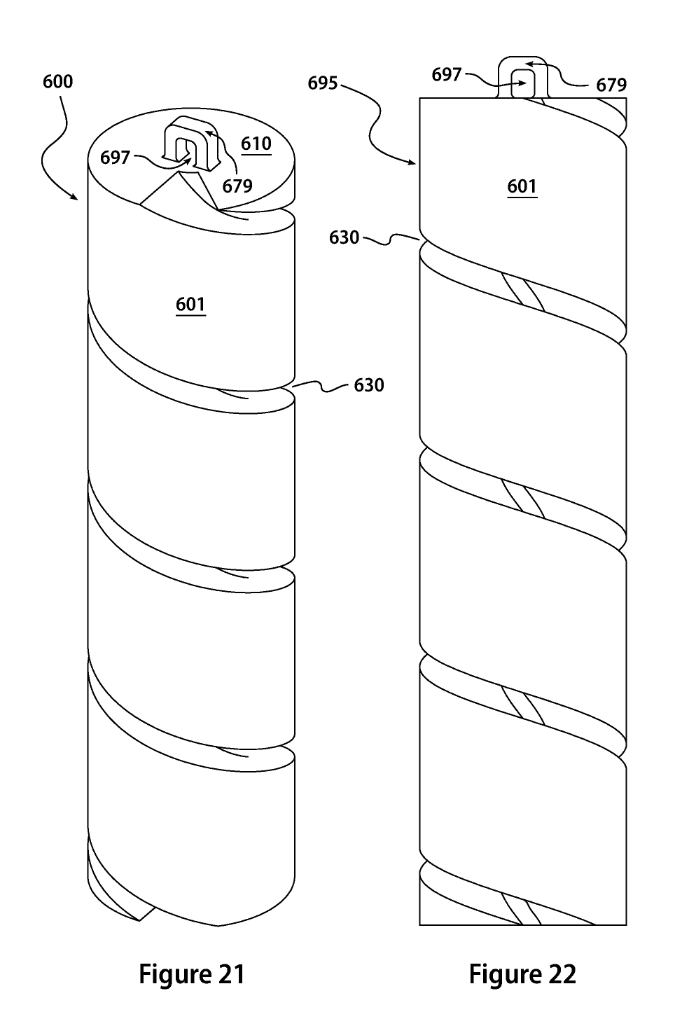

FIGS. 21 and 22 illustrate an example of a closed hanging loop 679 with hole 697 that together enable the support of an object 600 in accordance with the present invention. Loop 679 with hole 697 represent the topology of a 1-holed torus 695 and may enable object 600 to be hung from an appropriate, separate, user-selectable support element (e.g., a nail on wall, Christmas tree, string from rear-view minor in car, etc). Loop 679 may enable additional decorative elements to be attached to object 600. Loop 679 may be attached to object first circular face 610, object second circular face, object surface 601, object groove 630, and/or other elements of object as described elsewhere herein. Loop 679 may be situated in relation to first terminal end or second terminal end, and/or groove 630; such position may enable interaction between loop and terminal ends and/or groove.

A decorative object in accordance with the present invention may provide an aesthetically pleasing appearance through the presentation of an attractive overall three-dimensional shape and/or size of object, either as a single complete object or with respect to one or more groups of one or more components of an overall object. The perception of the three-dimensional shape and/or size of said object may vary based upon point-of-view, including but not limited to: all three dimensions viewed from any angle; all three dimensions viewed only from specific angles; fewer than all three dimensions viewed from any angle; fewer than all three dimensions viewed only from specific angles; only within a cross-section of two dimensions; other more specialized relationships between observer/user and object. Further, a decorative object in accordance with the present invention may provide an aesthetically pleasing appearance additionally or solely through the presentation: attractive elements of the object surface between portions of the at least one groove; attractive elements of the at least one groove and/or lips of the at least one groove; attractive elements within or upon the exterior lateral object surface; shape, size, position, arrangement, curvature, symmetry, edges, construction, and/or material selection of any surface or other component of the object; finishing performed and/or added on or to the object surface (including, but not limited to: artwork, insignia, decorative items, color [hue, chroma, and/or luminosity], texture, relief, and/or one or more of the surface-finishing techniques performed as part of the manufacturing processes, such as described elsewhere herein); attractive elements added or modified by the user of the object; and other additional attractive elements. Example surfaces for ornamentation in accordance with the present invention include, but are not limited to: first face (circular, square, hexagonal, kidney-shaped, elliptical, etc.); second face (circular, square, hexagonal, kidney-shaped, elliptical, etc.); first terminal end; second terminal end; groove (helical, first plurality, second plurality, etc.); support structure; object surface; any additional or other surface upon or within or comprising object.

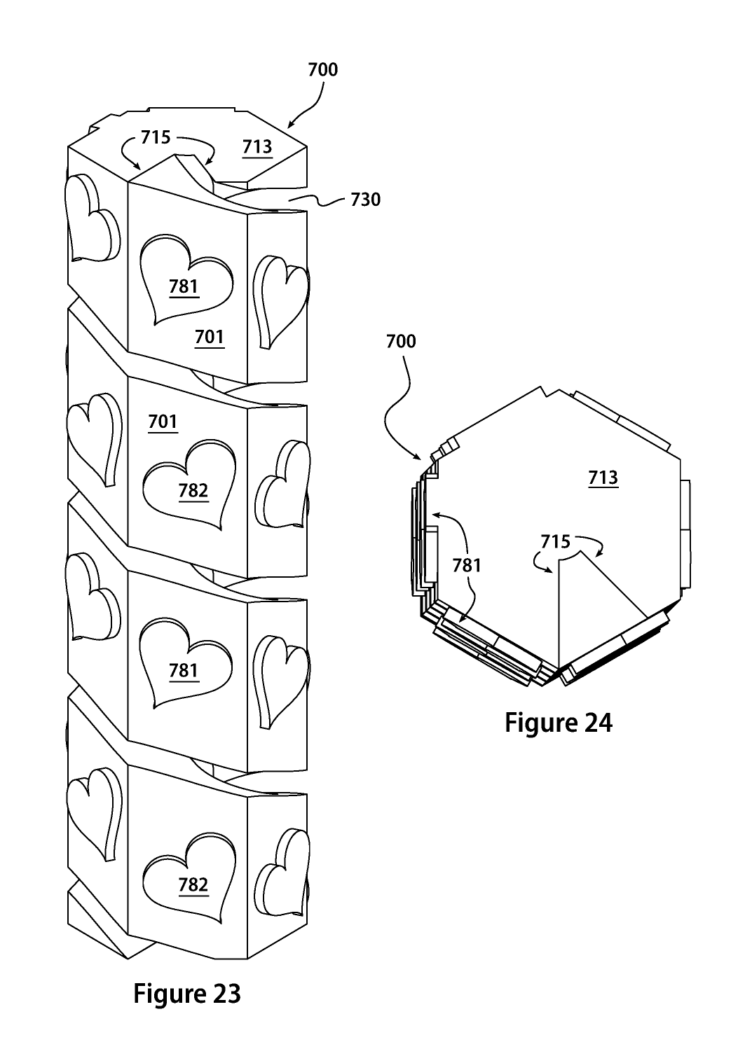

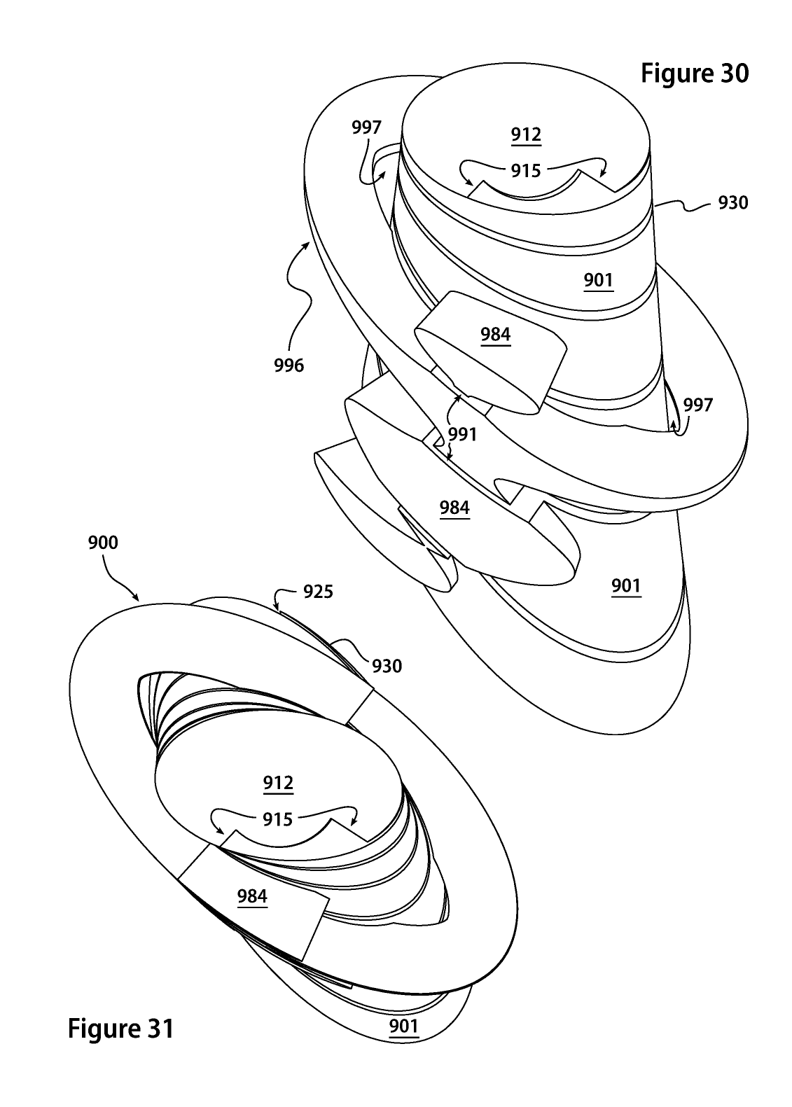

Three examples of ornamentation, in accordance with the present invention, are illustrated in FIGS. 23, 24, 25, 26, 27, 28, 29, 30, and 31. FIGS. 23 and 24 illustrate an example of a decorative object (with heart shapes on a hexagonal prism) in accordance with the present invention. Object 700 may comprise, in part, a right hexagonal prism with helical groove 730 in object surface 701. Groove 730 may connect first terminal end 715 on first hexagonal face 713 and second terminal end on second hexagonal face. Multiple decorative elements—right-leaning “heart” shape 781 and left-leaning “heart” shape 782—may be affixed to the prism to adorn object 700. Heart shapes 781,782 may, for example, have red pigmentation and/or glassy luster.

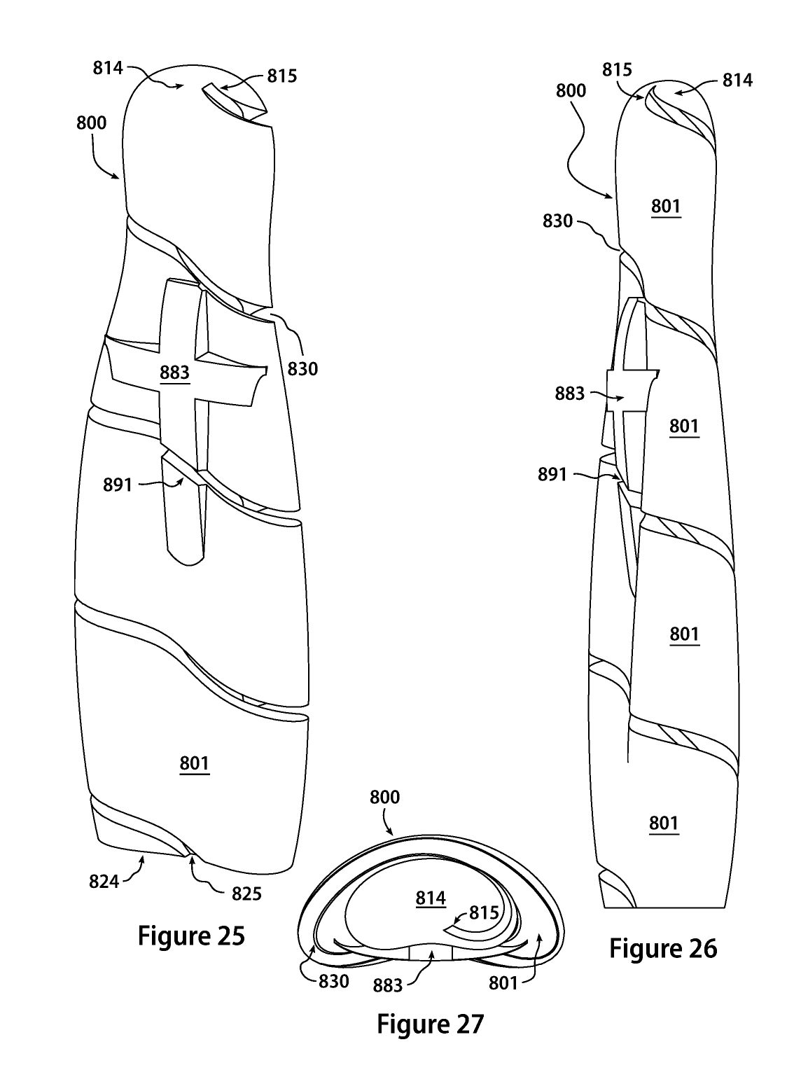

FIGS. 25, 26, and 27 illustrate an example of a decorative object (with Latin cross) in accordance with the present invention. Object 800 may comprise, in part, a complex three-dimensional shape, with an underlying cross-sectional shape of a non-polyhedral kidney. The cross-sectional kidney shape may vary in size along the vertical axis of the object. The kidney cross-section demonstrates both convexity and concavity in the bounding curve of its outline. Helical groove 830 wraps around object surface 801, connecting second terminal end 825 in second kidney face 824, with first terminal end 815 in first kidney dome 814. The object is adorned with a single large decorative element 883 of a “Latin Cross” with metallic gold pigmentation and peened texture, attached to object surface 801 and intersected by groove 830 at groove-object intersection 891.

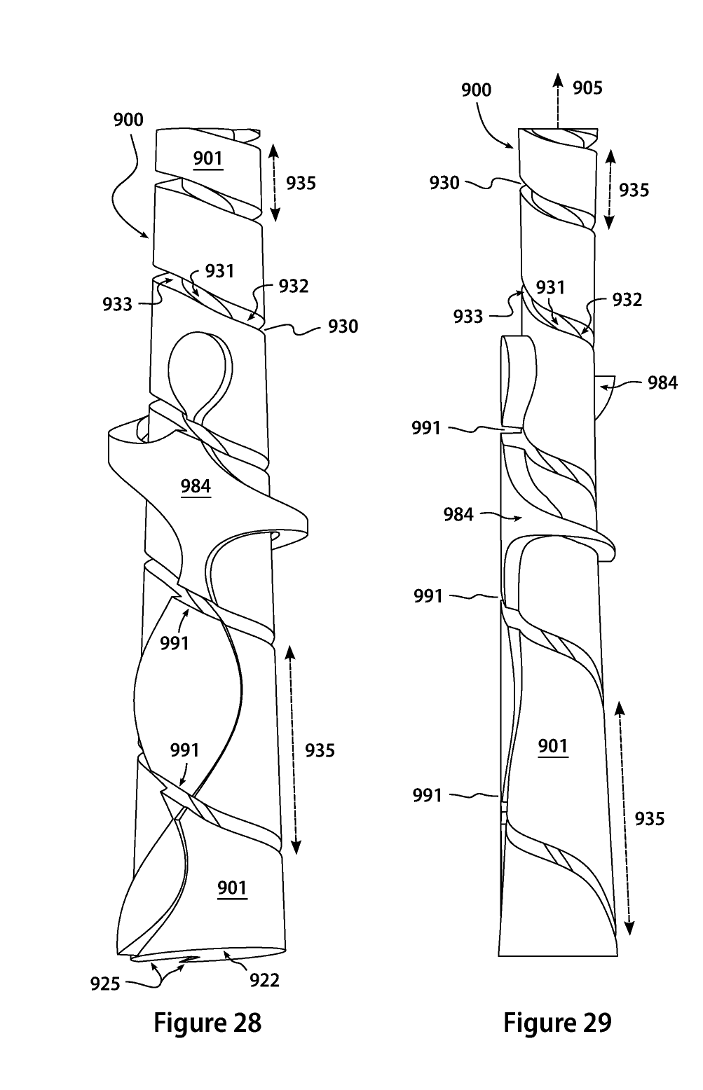

FIGS. 28, 29, 30, and 31 illustrate an example of a decorative object (with a dancing lady) in accordance with the present invention. Object 900 may comprise, in part, a frustum (truncated elliptical cone) stylistically distorted by rotation of underlying elliptical cross-section along first axis 905. Object 900 may include groove 930 (bounded by groove first sidewall 932, groove second sidewall 933, and groove floor 931) connecting second terminal end 925 in second elliptical face 922 with first terminal end 915 in first elliptical face 912. Groove 930 may be designed with variable spacing 935, decreasing with smaller conical cross-sections of the object, to add a decorative visual element. Decorative ornamentation may be further provided by abstract three-dimensional creation of dancing lady 984, suggestively wrapped around frustum, with head, torso, legs, and hands in contact with object surface 901 of frustum and upper arms protruding and unattached to object surface. Dancing lady 984 may demonstrate varied dimensionality or thickness, along first axis 905 of frustum. The protruding, unattached arms of dancing lady 984 may constitute holes 997 between each arm and the nearest portion of the frustum. Such holes 997 in object 900 enable it to be construed, in a mathematical sense, as n-holed torus 996. The inclusion of precious and/or semi-precious gemstones, such as rhinestones, upon the dancing lady may further allude to her festive demeanor. Groove 930 may intersect with dancing-woman ornamentation 984 at groove-ornament intersections 991, aesthetically positioned at the locations of narrower width of ornamentation 984 (neck, waist, and knees of dancing woman).

Aesthetic effects, design, artwork, and/or ornamentation, in accordance with the present invention, may draw upon certain unifying principles, as conventionally accepted, including but not limited to: visual unity, or harmony, of one or more components of the object; balance among one or more components of the object (via position, pigmentation, texture, perspective, various types and varying degrees of symmetry, and/or other methods); hierarchy among one or more components of the object (to convey relative importance, via relative size, shape, style, arrangement, and/or other methods); similarity (with or without variations) and/or contrast among one or more components of the object (to create subtle reinforcement or tension); proportion, or scale, and/or dominance, or emphasis, among one or more components of the object; use of negative space within or among one or more components of the object.

While examples of the provision or incorporation of additional decorative elements to an object are described elsewhere herein, aesthetic benefits may also derive from engineered manipulation of the center-of-mass and/or moments-of-inertia of the object. In some examples of the present invention, the center-of-mass/moments-of-inertia properties may be modified via overall shape of the object, arrangement of components comprising the object, and/or use of any additional decorative elements. Center-of-mass/moments-of-inertia properties may be adjusted via design decisions, including, but not limited to: use of different materials (with different properties, such as specific gravity or density) in different regions of the object; explicit construction or inclusion of internal voids or cavities at one or more locations in the object (potentially achieved via manufacturing methods, especially certain types of additive manufacturing, often parameterized as “in-fill” percentages of various internal domains); explicit addition or insertion of weights or other balancing components to the interior or the exterior of the object; etc. Modifications may vary along the length of the object, across the object, around the perimeter of the object, and/or via a more complicated three-dimensional form throughout the object interior and/or exterior elements. Engineered variations, such as these, might provide for more a preferable orientation, and/or better rotational stability, of the object and/or components of the object (including, but not limited to, decorative elements), when attached to the cord and subject to gravitational forces as well as other external stimuli of usage. Engineered variations (such as weights or balancing components or inclusion of voids) might be desirably observable or visible on the exterior surface of the object.

Objects in accordance with the present invention, or one or more components of said objects, may be manufactured, created, produced, formed, or otherwise made using various methods, including, but not limited to: subtractive manufacturing (milling, routing, boring, turning, planing, broaching, reaming, cutting, etc., as manual operation and/or via computer-numerical control [CNC]); additive manufacturing, commonly referred to as “3D printing” (fused-deposition modeling [FDM] or, synonymously, fused filament fabrication [FFF]; laminated object manufacturing [LOM]; stereolithography [SLA]; selective laser sintering [SLS]; selective laser melting [SLM]; etc.); molding (injection molding; rotational molding; thermoforming; powder metallurgy; compression molding; extrusion molding; laminating; transfer molding; etc.); casting (centrifugal casting or, synonymously, rotocasting; die casting; investment casting or, synonymously, lost-wax casting; glass casting; lost-foam casting (LFC); permanent mold casting; sand casting; slipcasting; spin casting; etc.); and others. The entire object may be produced via the same manufacturing method, or it may be produced via the same combination of multiple manufacturing methods (e.g., first method #1, then method #2, etc., in separate discrete steps). One or more components of the object or one or more groups of components of the object may each be produced by the same manufacturing method or combination of multiple manufacturing methods (differing from the manufacturing method or methods used by the remainder of the object), or may each be produced by different combinations of multiple manufacturing methods. The assembly of the final object from groups of components of the object, may be accomplished by different methods, including, but not limited to: adhesive bonds (two-part polyester resin; heat-curing urethanes; polymer dispersion adhesives; releasable adhesives; etc.); mechanical fasteners (bolts; clamps; clasps; clips; crimps; flanges; grommets; hook-and-loops; hooks; latches; snaps; screws; etc.); Chemical interactions (solvents on thermoplastic polymers; welding of metals; etc.); thermal catalysis; radiation (light) catalysis; pressure catalysis; etc. The application of one or more these methods (mechanical fasteners; adhesives; etc.) to properly enable, configure, position, form, and/or arrange the functional object to frictionally retain the headphone cord may be performed by the wearer of said headphones (the user of the object) while engaging the object with the headphone cord, rather than solely during the manufacturing process of the object. The application of one of more these methods (mechanical fasteners; adhesives; etc.) may enable the object to serve as a platform for additional ornamental or functional components to be affixed to the object and/or the headphone cord.

Two examples of different manufacturing methods of the object, in accordance with the present invention, are described herein. In the first example of an object made in accordance with the present invention, the basic shape and volume of the object is produced in aluminum via investment casting; subsequently, a groove is machined in the object via a CNC mill; next, ornamental additions are welded to the object; finally, pigmentation of the object is achieved through anodization. In the second example of an object made in accordance with the present invention, the entire object (body, groove, ornamentation, etc.) is produced with the same manufacturing method. The additive-manufacturing technique of fused-deposition modeling (FDM) is used to extrude polystyrene (PS) thermoplastic polymer into the shape of the final object (multiple separate extruders can be used to allow for thermoplastic of varying pigmentation); simultaneously, FDM techniques allow for the extrusion of polylactic acid (PLA) biopolymers to serve as dissolvable support structures (i.e., waste scaffolding), in order to enable complex object shapes, such as an inset groove in the object and overhanging ornamentation.

The creation of decorative elements, ornamental effects, artwork, and/or designs may be achieved (in whole or in part) as part of the formation of the object, including, but not limited to, the formation of: surface shapes, surface curvatures, protrusions, reliefs, inlays, trims, borders, edges, pipings, chamfers, fillets, colorings, pigmentations, textural effects, and/or any effects resulting from properties inherent in material selection. Said creation may be achieved through the use of one or more methods of subtractive manufacturing, additive manufacturing, molding, and casting. The creation of decorative elements, ornamental effects, artwork, and/or designs may be accomplished (in whole or in part) subsequent to the formation of the object, by techniques including, but not limited to: adding and/or altering the finish (anodizing; blanching; bluing; chromating; cladding; coating [powder, wet, with foils, with resins, and/or other coating methods]; crazing; depositing [chemical-vapor, electrophoretic, physical-vapor, pulsed-laser, sputter, and/or other depositing techniques]; dying [organic and/or inorganic]; gilding; glazing; knurling; painting; patinizing; phosphatizing; pigmenting; plating [electro, electroless, mechanical, vacuum, and/or other methods of plating]; printing [hot, intaglio, offset, pad, relief, screen, viscosity, and/or other printing methods]; thermal spraying; etc.); removing, reshaping, and/or modifying finish (abrasive blasting; brightening; buffing; burnishing; carving; engraving; etching; grinding; micromachining; peening; pickling; polishing [electrolytic, flame, high-finish, mop, vapor, vibration, and/or other polishing methods]; smoothing; and/or tumble finishing); as well as other methods not listed here. Decorative components may be created separately from the object and affixed to the object using assembly methods described herein. The choice of decorative techniques may be selected in accordance with the selection of material for the object or manufacturing process, and may achieve functional improvements to the object itself, or to the manufacturing process of the object, in addition to its ornamental benefits.

Examples of different methods to create decorative effects (with possible functional benefits as well), in accordance with the present invention, are described herein. In one example of an object made in accordance with the present invention, glitter may be applied to the first and second faces (circular, square, etc.) of the object in order to provide varying reflective properties. In another example, a two-dimensional bas-relief may be formed on the object surface, on which pigmentation or other adornment may also be added. A further example may involve gilding being added to the walls and floor of the groove in order to create a distinctive lustre and provide a distinctive visual offset from the frictionally-retained headphone cord. Tampography (pad-printing) of various designs or artworks on an object surface may be used to appeal to consumers with interest in particular subject matters. In some instances in accordance with the present invention, a portion or the entirety of a groove used to engage a headphone cord may be used to mechanically engage an ornamental component to the object. In a final example of an object made in accordance with the present invention, a transparent coating (potentially one cured by ultraviolet radiation) may be applied to the entire object to achieve a sensually smooth feel to the object surface, to conceal striations resulting from FDM manufacturing processes, and/or to improve the durability of the object.

Objects in accordance with the present invention, or one or more components of said objects, may be formed from a variety of different materials. An entire object may be formed from a single material, or that object may be formed from some aggregate of multiple materials. Alternatively, one or more components of an object or one or more groups of components of an object may each be formed by single materials that differ from the remainder of the object, or may each be formed by different aggregates of multiple materials. An aggregate of multiple materials may be comprised of materials bound together via physical connections or chemical interactions. Void spaces (representing the absence of material) may exist within, or as part of, the object, or components of the object; such voids may provide functional or aesthetic benefits. For example, they may contribute to the weight reduction of the object. As further example, they may shift the center-of-mass or moments-of-inertia of the object to increase its rotational stability or to better align a preferred viewpoint. Material characteristics might contribute to functional aspects, decorative aspects, or both functional and decorative aspects of the object.

In many examples in accordance with the present invention, the selection of materials or aggregates of multiple materials may provide different chemical/physical/functional properties to the object, and may provide different aesthetic benefits for the object. Materials may be selected to optimize one or more material characteristics, including, but not limited, to: acoustical properties (acoustical absorption; etc.); chemical properties (corrosion resistance; crystallinity; flammability; hygroscopy; miscibility; reactivity; solvent resistance; tacticity; toxicity; etc.); electrical properties (dielectric constant; dielectric strength; electric conductivity; electric hysteresis; electric resistance; electric susceptibility; ferroelectricity; flexoelectricity; inductance; piezoelectricity; pyroelectricity; relative permittivity; surface resistance; thermoelectricity; triboelectricity; etc.); financial characteristics (cost of processing of raw materials into object; cost of raw materials; homogeneity of cost basis in time and geography; etc.); magnetic properties (antiferromagnetism; ferrimagnetism; ferromagnetism; ferromagnetism; magnetic hysteresis; magnetic susceptibility; permeability; etc.); manufacturing properties (ability to be used in additive manufacturing methods (e.g., fused-deposition modeling [FDM]; laminated object manufacturing [LOM]; stereolithography [SLA]; selective laser sintering [SLS]; selective laser melting [SLM]; etc.); ability to hold tolerances; castability; ductility; durability; extrudability; moldability; malleability; machinability rating; metal fabrication; plasticity; thermoformability; etc.); mechanical properties (creep; coefficient of friction; coefficient of restitution; elastic hysteresis; fatigue limit; ferroelasticity; fracture toughness; mechanical impedance modulus [bulk/elastic/flexural/shear/specific/Young's]; plasticity; Poisson's ratio; shear strain; specific weight; specific gravity; stiffness; strength [compressive/flexural/impact/shear/specific/tensile/yield]; surface roughness; viscoelasticity; viscosity; etc.); optical properties (absorptivity; birefringence; color; indices of optical refraction; reflectivity; scattering; thermocromism; transmittance; etc.); supply-chain management issues (availability of raw materials; constancy of supply of raw materials over time; homogeneity of availability in time geography; multiplicity of sources of raw materials; etc.); Sustainability (ability to be derived from recycled sources; ability to produce recyclable object; environmental impact of use of material; power required to use material in production of object; etc.); thermal properties (emissivity; flammability; flash point; glass-transition temperature; liquid-vapor critical point; melt-flow index; melting temperature; phase diagram; specific heat capacity; thermal conductivity; thermal diffusivity; thermal expansion; thermochromism; etc.). Materials may be chosen with respect to their impact on the characteristics of the final state of the object, an initial state of production of the object, and any intermediary stage of production of the object. Materials may also be selected based upon the auxiliary (waste) portions or the components of the production process that do not directly comprise the produced object.

As an example of the benefit of different material selection, in accordance with the present invention, different materials may be used for or applied to the sidewalls and/or floor of the groove. Such material selection may provide resiliency when the cord is inserted or removed, may provide greater (or lesser) coefficients of friction while the cord is retained, and may provide various aesthetic benefits. In another example in accordance with the present invention, different materials may be used for the object surface, interior, and/or core; such material selection may provide improved temperature resistance (i.e., protection against being left in the car on a sunny day), may provide improved UV resistance (protection against fading of the pigmentation upon continuous outdoor usage), and may provide improved impact resistance (protection against damage if accidentally stepped upon, or very forcibly removed from frictional engagement of the headphone cord).

Objects in accordance with the present invention may be comprised of one or more of a variety of different materials, including, but not be limited to, the following: metals (alloys; aluminum; brass; bronze; copper; gold; iron; nickel; palladium; platinum; silver; steel; titanium; zinc; etc.); woods (latex rubber; etc.); textiles (cotton; silk; wool; etc., especially for fringes/tassels/etc.); Ceramics (composite materials; glass; oxides; etc.); resins (amber; pine-sap or other terpenes; etc.); thermoset polymers (bakelite; melamine resin; polyester resins; polyimides; polyurethanes; vulcanized rubber; etc.); thermoplastic polymers (acrylonitrile butadiene styrene (ABS); polyamide (PA) or, synonymously, nylon; polyamideimide (PAI); polyarylate (PAR); polybutylene terephthalate (PBT); polycarbonate (PC); polyetheretherketone (PEEK); polyetherimide (PEI); polyethersulfone (PES); polyethylene (PE); polyethylene Terephthalate (PET); polymethyl methacrylate (PMMA); polyoxymethylene (POM); polyphenylene oxide (PPO); polyphenylene sulfide (PPS); polyphenylsulfone (PPSU); polyphthalamide (PPA); polyphthalate carbonate (PPC); polypropylene (PP); polysiloxanes or, synonymously, silicone; polystyrene (PS); polysulfone (PSF); polyvinyl alcohol (PVA); polyvinyl chloride (PVC) or, synonymously, vinyl; polyvinylidene fluoride (PVDF); styrene acrylonitrile (SAN); styrene maleic anhydride (SMA); thermoplastic polyimide (TPI); etc.); biopolymers (polyhydroxyalkanoates (PHA); poly-3-hydroxybutyrate (PHB); polylactic acid (PLA); etc.).

Objects, or components of objects, in accordance with the present invention, may exhibit kinematic motion, or otherwise not be static in size, shape, volume, surface-area, relative position, symmetry, or internal relationship. Object, or components of objects, may be moveable under the force of gravity, under electrical power (e.g., battery, solar cell, and/or statically-charged element), under mechanical power (e.g., winding of a spring mechanism), and/or by the movement of the user/wearer of the object. The resulting motion may be observed or perceived within various points-of-view, including but not limited to: all three dimensions viewed from any angle; all three dimensions viewed only from specific angles; fewer than all three dimensions viewed from any angle; fewer than all three dimensions viewed only from specific angles; only within a cross-section of two dimensions; other more specialized relationships between observer/user and object. The movement may be enabled by creating structures or components from individual materials; from multiple materials; through interactions among multiple materials; through mechanical structures such as springs, hinges, joints, kinematic chains, or other functional relationships among components; or by other techniques. The object, structures, and/or components may flex, bend, stretch, compress, vibrate, undulate, wiggle, swing, gyrate, twist, resonate, roll, oscillate, rotate, deform, or otherwise change size and/or shape, or appear to change size and/or shape. They may respond to external human-induced stimula (e.g., from headphone-wearer or other individuals), and they may respond to external environmental stimula (e.g., from temperature changes, from exposure to water, from exposure to light, etc.). Objects, or components of objects, in accordance with the present invention may exhibit organized kinematics, including, but not limited to, the following: object may exhibit uniform motion throughout; One or more components of the object may exhibit uniform motion, while remainder of the object (if any) is stationary; two or more components of the object may exhibit non-uniform motion, while remainder of the object (if any) is stationary; Non-uniform motion of separate components of the object may be random; non-uniform motion of separate components of the object may be coupled and/or coordinated in nature (e.g., symmetric, anti-symmetric, etc.). The effects of said kinematic motion may provide functional benefits and/or ornamental effects.

Objects, or components of objects, in accordance with the present invention, may integrate light sources. Light sources may comprise light-emitting diodes (LEDs) or any other source of electro-magnetic radiation (including fluorescence, chemiluminescence, phosphorescence, electroluminescence, triboluminescence, as well as other methods). Light may be emitted with visible wavelengths (broad-spectrum, narrow-spectrum, monochromatic, etc.) and/or with non-visible wavelengths (ultraviolet [UV], infrared [IR], etc.). One or more light sources may demonstrate temporal dependencies, including, but not limited to, one or more of the following: intensity of light (including zero intensity, or turned off); frequency or frequency range of light; direction of light; etc. Light source may be placed in one or more positions on the object, and aimed in one or more directions, including but not limited to, the following: situated in the object interior and/or object core (generating a “glow” of light seen through a transparent or semi-transparent material comprising the object surface); attached on the exterior lateral surface of the object (flush with the surface, protruding from the surface, partially embedded within the surface, or via other mechanisms); attached to, or within, the groove of the object, or one or more lips of the groove of the object; attached to or comprising the support-structure of the object; attached to one or more of the terminal ends of the object; etc. The effect of light sources may be to provide functional benefits and/or ornamental effects.

Objects, or components of objects, in accordance with the present invention, may integrate audio sources and/or receivers. Audio sources may comprise speakers or any other source capable of creating sound-waves, including audible frequencies and inaudible frequencies. Audio receivers may comprise microphones or any other receiver capable of absorbing sound-waves. Audio sources and receivers may provide functional benefits and/or ornamental effects.

Objects, or components of objects, in accordance with the present invention, may integrate heat sources, provided by resistive electrical elements, chemical elements, radiative elements (visible or invisible light). The effect of heat sources may provide functional benefits and/or ornamental effects.

The dynamic behavior of kinematic motion, light sources, audio sources/receivers, and/or heat sources may be controlled by various processes. In one example in accordance with the present invention, said dynamic behavior may be controlled directly by explicit user-interaction with the object. In another example in accordance with the present invention, the behavior may be controlled indirectly by explicit remote user-interaction with external devices (e.g., smart-phone, smart-watch, etc.). In a further example, the behavior may be controlled via a causal relationship with the external environment or external devices, without necessarily explicit user-interaction.

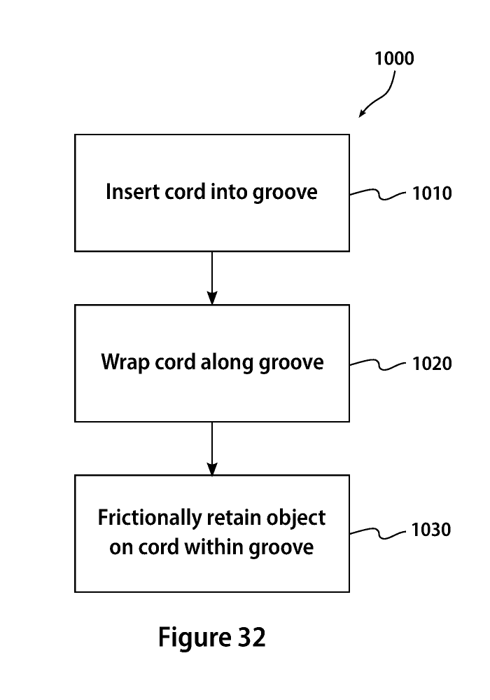

FIG. 32 illustrates an example of method 1000, in accordance with the present invention, whereby an object may be affixed to a headphone cord via a series of actions taken by the user of the object. Method 1000 may begin with step 1010 of inserting the cord into a groove in the surface of the object (e.g., inserting the cord into the first terminal end of a groove, which may be at the first end of the longer axis of an object with longer and shorter axes). Method 1000 may continue with step 1020 of wrapping the cord along a groove around the object (e.g., wrapping the cord at least one revolution around the object; or wrapping the cord a plurality of revolutions; or wrapping the cord along a groove from the first terminal end to the second terminal end, with the second terminal end provided on the surface of the object, at the second end of the longer axis of the object). Method 1000 may conclude with step 1030 of frictionally retaining the object on the cord within a groove (e.g., by contacting at least one surface of a groove; or by contacting at least one of a first sidewall, a second sidewall, and a floor).

In accordance with the present invention, a decorative object may be affixed to a headphone cord using one or more grooves or channels in the object surface. The object may be affixed by inserting the cord into the object's groove, wrapping the cord along the groove around the object, and frictionally retaining the object on the cord within the groove. A decorative object affixed to a headphone cord in such a manner may enable aesthetic benefit for the user wearing these headphones, by putting the object's ornamentation on display. Further, the object may be prevented from falling or being easily dislodged from the cord and from sliding or rotating along the cord. Tension along a malleable cord as well as gravitational forces may help ensure frictional contact between the cord and the object. In accordance with the present invention, decorative objects may be affixed to various categories of cords, which may be comprised of a single filament or of multiple filaments bundled together. Cords may be headphone cords, as described throughout. Cords may be locks or strands of wearer's hair. Cords may also be embodied by shoelaces, drawstrings, and balloon-strings.

1. An object affixable to a cord, the object comprising:
a lateral exterior surface;
a core within the interior of the object;
at least one groove formed into the lateral exterior surface of the object and extending at least one revolution around the lateral exterior surface, the at least one groove having sidewalls extending from the lateral exterior surface to the core, the at least one groove having a width between the sidewalls sufficient to receive the cord; and
at least one decorative element visible on the object.

2. The object of claim 1, wherein the at least one groove extends a plurality of revolutions around the lateral exterior surface.

3. The object of claim 2, wherein the at least one groove comprises a single groove.

4. The object of claim 3, wherein the at least one decorative element is on at least a portion of the lateral exterior surface.

5. The object of claim 4, wherein the at least one decorative element comprises pigmentation applied to the lateral exterior surface.

6. The object of claim 4, wherein the at least one decorative element comprises a shape affixed to the lateral exterior surface.

7. The object of claim 1, wherein the object has a first axis, a second axis, and a third axis, and wherein the object extends further along the first axis than along the second axis and the third axis.

8. The object of claim 1, wherein the at least one groove comprises a plurality of grooves, the grooves within the plurality of grooves selectable by a user to receive the cord for at least one revolution around the lateral exterior surface.

9. The object of claim 8, wherein the plurality of grooves selectable by a user further comprises a first plurality of grooves and a second plurality of grooves, grooves of the first plurality of grooves intersecting grooves of the second plurality of grooves such that a cord may be engaged at least one revolution around the lateral exterior surface within at least one of the first plurality of grooves and at least one of the second plurality of grooves.

10. The object of claim 1, further comprising at least one cavity within the object, the at least one cavity having a size, a shape, and a location selected to hold the object in a desired orientation while the cord is frictionally retained within the at least one groove.

11. The object of claim 1, wherein the object is formed of a material having a varying density within the object, the density varied so as to hold the object in a desired orientation while the cord is frictionally retained within the at least one groove.

12. The object of claim 1, wherein the cord comprises a headphone cord and the object displays the at least one decorative element when the object is affixed to the headphone cord.

13. The object of claim 12, wherein the object is formed of a material having a varying density within the object, the density varied so as to hold the object in a desired display orientation while the headphone cord is frictionally retained within the at least one groove.

14. An item for affixing to a cord, the item comprising a surface defining an object, the surface topologically equivalent to a sphere, the surface providing at least one groove having sidewalls and a floor, the at least one groove configured to receive a cord and frictionally retain the item on the cord.

15. The item for affixing to a cord of claim 14, wherein the at least one groove frictionally retains the item on the cord by contacting the cord to at least one of the sidewalls and floor.

16. The item for affixing to a cord of claim 15, wherein the at least one groove extends at least one revolution around a first axis of the object.

17. The item for affixing to a cord of claim 14, wherein the first axis extends substantially parallel to a portion of the cord not frictionally retained within the at least one groove.

18. The item for affixing to a cord of claim 14, wherein the at least one groove comprises a single groove.

19. The item for affixing to a cord of claim 14, wherein the at least one groove comprises a plurality of grooves.

20. An item for affixing to a cord, the item comprising a surface defining an object, the surface topologically equivalent to an n-holed torus, the surface providing at least one groove having sidewalls and a floor, the at least one groove configured to receive a cord and frictionally retain the item on the cord.

21. The item for affixing to a cord of claim 20, wherein at least one hole of the n-holed surface receives an item other than the cord.

22. The item for affixing to a cord of claim 21, wherein at least one hole of the n-holed surface receives a decorative object.

23. The item for affixing to a headphone cord of claim 20, wherein the n-holed torus comprises a 1-holed torus.

24. A method for affixing an object to a cord, the method comprising:
inserting the cord into a groove provided in a surface of the object;
wrapping the cord along the groove at least one revolution around the object; and
frictionally retaining the object on the cord within the groove.

25. The method for affixing an object to a cord of claim 24, wherein wrapping the cord along the groove at least one revolution comprises wrapping the cord a plurality of revolutions.

26. The method for affixing an object to a cord of claim 25, wherein frictionally retaining the object on the cord within the groove comprises frictionally contacting at least one surface defining the groove.

27. The method for affixing an object to a cord of claim 26, wherein frictionally contacting at least one surface defining the groove comprises contacting at least one of a first sidewall, a second sidewall, and a floor.

28. The method for affixing an object to a cord of claim 27, wherein inserting the cord into a groove provided in a surface of the object comprises inserting the cord into a first terminal end of the groove.

29. The method for affixing an object to a cord of claim 28, wherein the object has a longer axis and a shorter axis, and the first terminal end of the groove is provided in the surface of the object at a first end of the longer axis of the object.

30. The method for affixing on object to a cord of claim 29, wherein wrapping the cord along the groove comprises wrapping the cord along the groove from the first terminal end to a second terminal end, the second terminal end provided on the surface of the object at a second end of the longer axis of the object.
